(19) United States
(12) Patent Application Publication
(10) Pub. No.: US 2020/0342869 A1
(43) Pub. Date: Oct. 29, 2020

(54) ELECTRONIC DEVICE AND METHOD FOR CONTROLLING VOICE SIGNAL

(71) Applicant: Samsung Electronics Co., Ltd., Gyeonggi-do (KR)

(72) Inventors: Yo-Han LEE, Gyeonggi-do (KR); Won-Sik SONG, Seoul (KR); Jung-Kyun RYU, Gyeonggi-do (KR); Jun Ho PARK, Seoul (KR); Jong Chan WON, Gyeonggi-do (KR); Seungyong LEE, Gyeonggi-do (KR); Young-Su LEE, Gyeonggi-do (KR)

(21) Appl. No.: 16/757,016

(22) PCT Filed: Oct. 16, 2018
(86) PCT No.: PCT/KR2018/012168

§ 371 Date: Apr. 17, 2020

(30) Foreign Application Priority Data
Oct. 17, 2017 (KR) 10-2017-0134542

(51) Int. Cl. G10L 15/22; G06F 3/16; H04B 17/318; G10L 25/60; G10L 15/30; G10L 19/00; G10L 15/08

(52) U.S. Cl. CPC G10L 15/22; G06F 3/167; H04B 17/318; H04W 4/70; G10L 15/30; G10L 19/00; G10L 15/08; G10L 25/60

(57) ABSTRACT

An electronic device according to various embodiments may include: a microphone; a speaker; a wireless communication circuit set to support wireless fidelity (Wi-Fi); a processor operatively connected to the microphone, the speaker, and the wireless communication circuit, and a memory operatively connected to the processor, wherein the memory can store instructions which upon being executed cause the processor to: receive first user utterances through the microphone; transmit first data, including first voice data related to the first user utterances and first metadata related to the first voice data, to an external server through the wireless communication circuit; and receive, from the external server through the wireless communication circuit, a response related to the electronic device selected as an input device for a voice-based service.

### TECHNCIAL FIELD

The disclosure relates to an electronic device and a method for controlling a voice signal.

### BACKGROUND ART

Various embodiments may be related to a technology for a sensor network, Machine-to-Machine (M2M) communication, Machine-Type Communication (MTC), and the Internet of Things (IoT). Various embodiments can be used in intelligent services based on such technology (smart homes, smart buildings, smart cities, smart cars or connected cars, healthcare, digital education, retail business, security, and safety-related services).

### DISCLOSURE OF INVENTION

### Technical Problem

Due to the development of wireless communication technology, electronic devices for the Internet of Things (IoT) have been developed. Such electronic devices may receive voice signals from a user for interaction with the user. The quality of voice signals received by the electronic devices may differ depending on the capability of an element (for example, a microphone) included in each of the devices and the distance between each of the devices and the user. Accordingly, a method of controlling the voice signal may be required within a system including the electronic devices.

Various embodiments may provide an electronic device and a method for controlling a voice signal on the basis of signaling between a server linked to electronic devices and the electronic devices.

The technical subjects pursued in the disclosure may not be limited to the above mentioned technical subjects, and other technical subjects which are not mentioned may be clearly understood, through the following descriptions, by those skilled in the art to which the disclosure pertains.

### Solution to Problem

In accordance with an aspect of the disclosure, a system is provided. The system includes a network interface, at least one processor operatively connected to the network interface, and at least one memory operatively connected to the at least one processor, wherein the memory stores instructions causing the at least one processor to, when executed, receive first data including first voice data related to a first user utterance and first metadata related to the first voice data through the network interface from a first external device, receive second data including second voice data related to the first user utterance and second metadata related to the second voice data from a second external device through the network interface, select one device from among the first external device and the second external device on the basis of at least the first metadata and the second metadata, provide a response related to the one selected device to the one selected device, and receive third data related to a second user utterance from the one selected device.

In accordance with another aspect of the disclosure, an electronic device is provided. The electronic device includes a microphone, a speaker, a wireless communication circuit configured to support Wireless Fidelity (Wi-Fi), a processor operatively connected to the microphone, the speaker, and the wireless communication circuit, and a memory operatively connected to the processor, wherein the memory may store instructions causing the processor to, when executed, receive a first user utterance through the microphone, transmit first data including first voice data related to the first user utterance and first metadata related to the first voice data to an external server through the wireless communication circuit, and receive a response related to an electronic device selected as an input device for a voice-based service from the external server through the wireless communication circuit.

In accordance with another aspect of the disclosure, an electronic device is provided. The electronic device includes a microphone, a communication interface, and at least one processor configured to receive a voice signal through the microphone, identify a wake-up command within the voice signal, determine a value indicating a reception quality of the voice signal based at least on the wake-up command, and transmit information on the determined value to a server through the communication interface.

In accordance with another aspect of the disclosure, a server is provided. The server includes a communication interface and a processor configured to receive information on a first value indicating a reception quality of a voice signal received by a first electronic device from the first electronic device through the communication interface, receive information on a second value indicating a reception quality of the voice signal received by a second electronic device from the second electronic device through the communication interface, determine an electronic device to transmit a voice command included in the voice signal among a plurality of electronic devices including the first electronic device and the second electronic device based at least on the first value and the second value and transmit a message indicating transmission of information on the voice command to the determined electronic device through the communication interface.

In accordance with another aspect of the disclosure, a method of a system is provided. The method includes receiving first data including first voice data related to a first user utterance and first metadata related to the first voice data through the network interface from a first external device, receiving second data including second voice data related to the first user utterance and second metadata related to the second voice data from a second external device through the network interface, selecting one device from among the first external device and the second external device on the basis of at least the first metadata and the second metadata, providing a response related to the one selected device to the one selected device, and receiving third data related to a second user utterance from the one selected device.

In accordance with another aspect of the disclosure, a method of an electronic device is provided. The method includes receiving a first user utterance through the microphone of the electronic device, transmitting first data including first voice data related to the first user utterance and first metadata related to the first voice data to an external server through the wireless communication circuit of the electronic device, and receiving a response related to an electronic device selected as an input device for a voice-based service from the external server through the wireless communication circuit.

In accordance with another aspect of the disclosure, a method of an electronic device is provided. The method includes receiving a voice signal through the microphone of the electronic device, identifying a wake-up command within the voice signal, determining a value indicating a reception quality of the voice signal on the basis of at least the wake-up command, and transmitting information on the determined value to a server through the communication interface.

In accordance with another aspect of the disclosure, a method of a server is provided. The method includes receiving information on a first value indicating a reception quality of a voice signal received by a first electronic device from the first electronic device through the communication interface, receiving information on a second value indicating a reception quality of the voice signal received by a second electronic device from the second electronic device through the communication interface, determining an electronic device to transmit a voice command included in the voice signal among a plurality of electronic devices including the first electronic device and the second electronic device on the basis of at least the first value and the second value, and transmitting a message indicating transmission of information on the voice command to the determined electronic device through the communication interface.

### ADVANTAGEOUS EFFECTS OF INVENTION

An electronic device and a method thereof according to various embodiments can provide an effective service by recognizing a voice signal on the basis of signaling with a server.

Effects obtainable from the disclosure may not be limited to the above mentioned effects, and other effects which are not mentioned may be clearly understood, through the following descriptions, by those skilled in the art to which the disclosure pertains.

### BRIEF DESCRIPTION OF DRAWINGS

FIG. 1 illustrates an integrated intelligence system according to various embodiments of the disclosure;

FIG. 2 is a block diagram illustrating a UE in an integrated intelligence system according to an embodiment of the disclosure;

FIG. 3 illustrates execution of an intelligent app of a UE according to an embodiment of the disclosure;

FIG. 4 illustrates collection of a current state by a context module of an intelligent service module according to an embodiment of the disclosure;

FIG. 5 is a block diagram illustrating a proposal module of an intelligent service module according to an embodiment of the disclosure;

FIG. 6 is a block diagram illustrating an intelligent server of an integrated intelligence system according to an embodiment of the disclosure;

FIG. 7 illustrates a method of generating a path rule by a path Natural Language Understanding (NLU) module according to an embodiment of the disclosure;

FIG. 8 illustrates management of user information by a persona module of an intelligence service module according to an embodiment of the disclosure;

FIG. 9 illustrates an example of an environment including a plurality of electronic devices according to various embodiments;

FIG. 10 illustrates an example of the functional configuration of an electronic device performing an operation related to voice recognition according to various embodiments;

FIG. 11 illustrates another example of the functional configuration of the electronic device performing the operation related to voice recognition according to various embodiments;

FIG. 12 illustrates an example of the functional configuration of a server according to various embodiments;

FIG. 13A illustrates an example of operation of an electronic device according to various embodiments;

FIG. 13B illustrates another example of the operation of the electronic device according to various embodiments;

FIG. 14A illustrates an example of operation of a server according to various embodiments;

FIG. 14B illustrates another example of operation of a server according to various embodiments;

FIG. 15 illustrates an example of signaling between a plurality of electronic devices and a server according to various embodiments;

FIG. 16 illustrates an example of formats of voice signals received by a plurality of electronic devices according to various embodiments;

FIG. 17 illustrates another example of signaling between a plurality of electronic devices and a server according to various embodiments;

FIG. 18 illustrates another example of signaling between a plurality of electronic devices and a server according to various embodiments;

FIG. 19 illustrates an example of an operation of a server providing feedback according to various embodiments;

FIG. 20 illustrates another example of signaling between a plurality of electronic devices and a server according to various embodiments;

FIG. 21 illustrates an example of another operation of the server according to various embodiments;

FIG. 22 illustrates another example of signaling between a plurality of electronic devices and a server according to various embodiments;

FIG. 23 illustrates an example of an operation of a server performing noise canceling on a voice command according to various embodiments;

FIG. 24 illustrates another example of an environment including a plurality of electronic devices according to various embodiments;

FIG. 25 illustrates another example of signaling between a plurality of electronic devices and a server according to various embodiments; and

FIG. 26 illustrates another example of signaling between a plurality of electronic devices and a server according to various embodiments.

### BEST MODE FOR CARRYING OUT THE INVENTION

Prior to the description of an embodiment of the disclosure, an integrated intelligence system to which an embodiment of the disclosure can be applied is described.

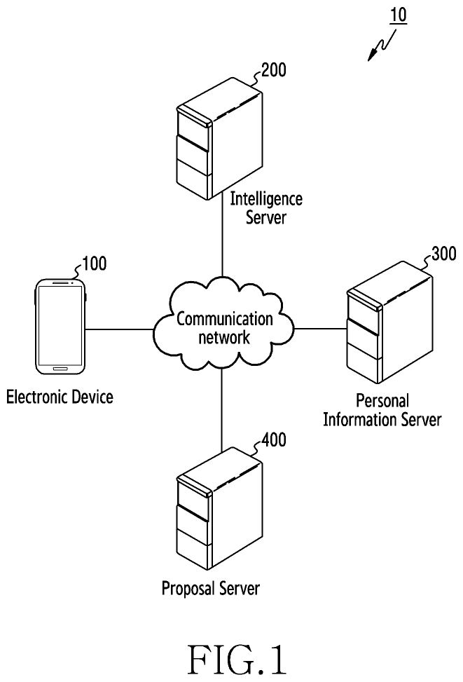

FIG. 1 is a diagram illustrating an integrated intelligence system according to various embodiments of the disclosure.

Referring to FIG. 1, the integrated intelligence system 10 may include a user terminal 100, an intelligence server 200, a personal information server 300, or a proposal server 400.

The user terminal 100 may provide a service necessary for a user through an app (or application program) (for example, alarm app, message app, picture (gallery) app, or the like) stored inside the user terminal 100. For example, the user terminal 100 may execute and operate another app through an intelligence app (or voice recognition app) stored inside the user terminal 100. A user input for executing and operating the other app through the intelligence app inside the user terminal 100 may be received. The user input may be received, for example, through a physical button, a touch pad, a voice input, a remote input, or the like. According to an embodiment, the user terminal 100 may correspond to various kinds of terminal devices (or electronic devices) that can be connected to the Internet, such as a mobile phone, a smartphone, a personal digital assistant (PDA), a laptop computer, or the like.

According to an embodiment, the user terminal 100 may receive the user's speech as a user input. The user terminal 100 may receive the user's speech and may produce a command that operates an app based on the user's speech. Accordingly, the user terminal 100 may operate the app by using the command.

The intelligence server 200 may receive a user voice input from the user terminal 100 through a communication network and may change the same to text data. In another embodiment, the intelligence server 200 may produce (or select) a path rule based on the text data. The path rule may include information regarding an action (or operation) for performing a function of the app, or information regarding a parameter necessary to execute the action. In addition, the path rule may include the order of the operations of the app. The user terminal 100 may receive the path rule, may select an app according to the path rule, and may execute an action included in the path rule in connection with the selected app.

The term “path rule” as used herein may generally refer to a sequence of states needed by an electronic device to perform a task requested by a user, but is not limited thereto. In other words, the path rule may include information regarding a sequence of states. The task may be an action that an intelligent app can provide, for example. The task may include producing a schedule, transmitting a picture to a desired counterpart, or providing weather information. The user terminal 100 may successively have at least one or more states (for example, operating state of the user terminal 100), thereby performing the task.

According to an embodiment, the path rule may be provided or produced by an artificial intelligent (AI) system. The AI system may be a rule-base system or a neural network-based system (for example, feedforward neural network (FNN) or recurrent neural network (RNN)).

Alternatively, the AI system may be a combination of the above-mentioned systems, or an AI system different therefrom. According to an embodiment, the path rule may be selected from a set of path rules defined in advance, or may be produced in real time in response to a user request. For example, the AI system may select at least a path rule from multiple predefined path rules, or may produce a path rule dynamically (or in real time). In addition, the user terminal 100 may use a hybrid system to provide the path rule.

According to an embodiment, the user terminal 100 may execute the action and may display a screen corresponding to the state of the user terminal 100 that executed the action on the display. As another example, the user terminal 100 may execute the action and may not display the result of performing the action on the display. The user terminal 100 may execute multiple operations, for example, and may display the result of only some of the multiple actions on the display. The user terminal 100 may display only the result of executing the last action in the order, for example, on the display. As another example, the user terminal 100 may display the result of receiving the user's input and executing the action on the display.

The personal information server 300 may include a database in which user information is stored. For example, the personal information server 300 may receive user information (for example, context information, app execution, and the like) from the user terminal 100 and may store the same in the database. The intelligence server 200 may receive the user information from the personal information server 300 through a communication network and may use the same when producing a path rule regarding a user input. According to an embodiment, the user terminal 100 may receive user information from the personal information server 300 through a communication network and may use the same as information for managing the database.

The proposal server 400 may include a database storing information regarding introduction of a function or an application inside the terminal, or a function to be provided. For example, the proposal server 400 may include a database regarding a function that the user can use after receiving user information of the user terminal 100 from the personal information server 300. The user terminal 100 may receive information regarding the function to be provided, from the proposal server 400 through a communication network, and may provide the information to the user.

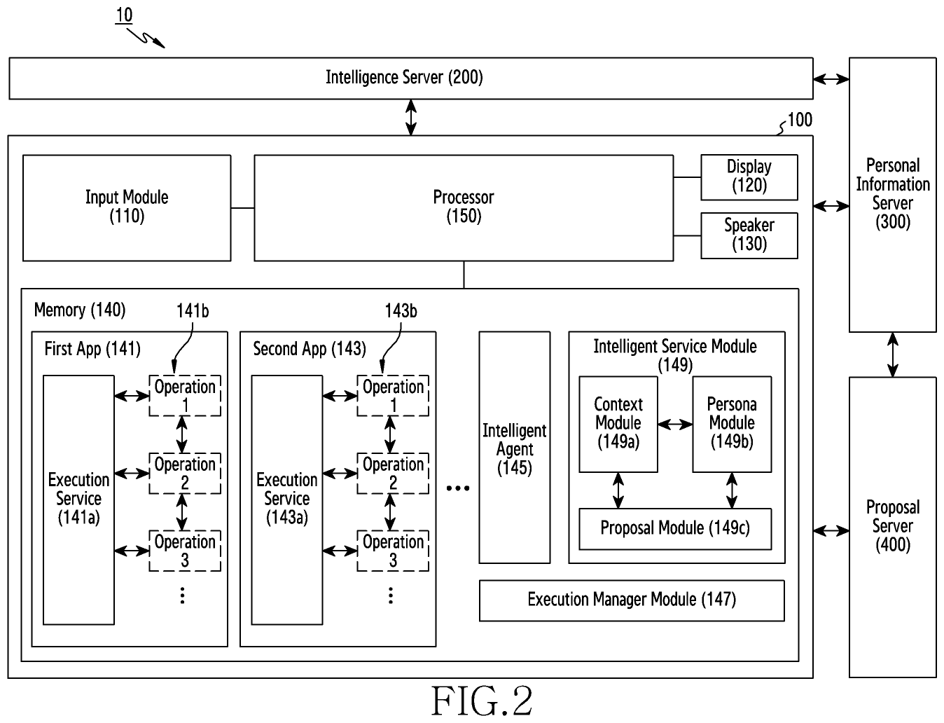

FIG. 2 is a block diagram illustrating a UE in an integrated intelligence system according to an embodiment of the disclosure.

Referring to FIG. 2, a UE 100 may include an input module 110, a display 120, a speaker 130, a memory 140, or a processor 150. The UE 100 may further include a housing, and the elements of the UE 100 may be located within the housing or on the housing. The UE 100 may further include a communication circuit located within the housing. The UE 100 may transmit and receive data (or information) to and from an external server (for example, an intelligent server 200) through the communication circuit.

The input module 110 according to an embodiment may receive user input from the user. For example, the input module 110 may receive user input from a connected external device (for example, a keyboard or a headset). In another example, the input module 110 may include a touch screen (for example, a touch screen display) coupled to the display 120. In another example, the input module 110 may include a hardware key (or a physical key) located in the UE 100 (or the housing of the UE 100).

According to an embodiment, the input module 110 may include a microphone capable of receiving a user utterance as a voice signal. For example, the input module 110 may include a speech input system and receive a user utterance as a voice signal through the speech input system. The microphone may be exposed through, for example, a part (for example, a first part) of the housing.

The display 120 according to an embodiment may display an image, a video, and/or an application execution screen. For example, the display 120 may display a Graphic User Interface (GUI) of an app. According to an embodiment, the display 120 may be exposed through a part (for example, a second part) of the housing.

According to an embodiment, the speaker 130 may output a voice signal. For example, the speaker 130 may output a voice signal generated inside the UE 100 to the outside. According to an embodiment, the speaker 130 may be exposed through a part (for example, a third part) of the housing.

According to an embodiment, the memory 140 may store a plurality of apps 141 and 143 (or applications). The plurality of apps 141 and 143 may be programs for performing functions corresponding to, for example, user input. According to an embodiment, the memory 140 may store the intelligent agent 145, the execution manager module 147, or the intelligent service module 149. The intelligent agent 145, the execution manager module 147, or the intelligent service module 149 may be frameworks (or application frameworks) for processing, for example, received user input (for example, user utterances).

According to an embodiment, the memory 140 may include a database that may store information required for recognizing the user input. For example, the memory 140 may include a log database for storing log information. In another example, the memory 140 may include a persona database for storing user information.

According to an embodiment, the memory 140 may store the plurality of apps 141 and 143, and the plurality of apps 141 and 143 may be loaded and executed. For example, the plurality of apps 141 and 143 stored in the memory 140 may be loaded and executed by the execution manager module 147. The plurality of apps 141 and 143 may include execution service modules 141a and 143a for performing functions. According to an embodiment, the plurality of apps 141 and 143 may perform a plurality of operations 141b and 143b (for example, sequences of states) through the execution service modules 141a and 143a to perform functions. In other words, the execution service modules 141a and 143a may be activated by the execution manager module 147 and may perform the plurality of operations 141b and 143b.

According to an embodiment, when the operations 141b and 143b of the apps 141 and 143 are performed, execution state screens according to execution of the operations 141b and 143b may be displayed on the display 120. The execution state screens may be, for example, screens shown in the state in which the operations 141b and 143b are completed. In another example, the execution state screens may be screens shown in the state in which execution of the operations 141b and 143b is stopped (partial landing) (for example, in the state in which a parameter required for the operations 141b and 143b has not been input).

The execution service modules 141a and 143a according to an embodiment may perform the operations 141b and 143b according to a path rule. For example, the execution service modules 141a and 143a may be activated by the execution manager module 147, receive an execution request from the execution manager module 147 according to the path rule, and perform the operations 141b and 143b in response to the execution request so as to perform the functions of the apps 141 and 143. When the operations 141b and 143b have been completely performed, the execution service modules 141a and 143a may transmit completion information to the execution manager module 147.

According to an embodiment, when the plurality of operations 141b and 143b is performed by the apps 141 and 143, the plurality of operations 141b and 143b may be sequentially performed. When one operation (for example, operation 1 of the first app 141 or operation 1 of the second app 143) is completely performed, the execution service modules 141a and 143a may open the next operation (for example, operation 2 of the first app 141 and operation 2 of the second app 143) and transmit completion information to the execution manager module 147. Here, opening a predetermined operation may be understood to be transitioning the predetermined operation to an executable state or preparing for execution of the predetermined operation. In other words, when the predetermined operation is not open, the corresponding operation cannot be performed. When receiving the completion information, the execution manager module 147 may transmit an execution request for the next operation (for example, operation 2 of the first app 141 and operation 2 of the second app 143) to the execution service module. According to an embodiment, when the plurality of apps 141 and 143 is executed, the plurality of apps 141 and 143 may be executed sequentially. For example, when execution of the last operation of the first app 141 (for example, operation 3 of the first app 141) is completed and completion information is received, the execution manager module 147 may transmit a request for executing the first operation of the second app 143 (for example, operation 1 of the second app 143) to the execution service 143a.

According to an embodiment, when the plurality of operations 141b and 143b is performed by the apps 141 and 143, a result screen according to execution of each of the plurality of performed operations 141b and 143b may be displayed on the display 120. According to an embodiment, only some of the plurality of result screens according to the execution of the plurality of performed operations 141b and 143b may be displayed on the display 120.

According to an embodiment, the memory 140 may store an intelligent app (for example, a voice recognition app) linked to the intelligent agent 145. The app linked to the intelligent agent 145 may receive and process a user utterance as a voice signal. According to an embodiment, the app linked to the intelligent agent 145 may operate according to specific input (for example, input through a hardware key, input through a touch screen, or a specific voice input) made through the input module 110.

According to an embodiment, the intelligent agent 145, the execution manager module 147, or the intelligent service module 149 stored in the memory 140 may be executed by the processor 150. The function of the intelligent agent 145, the execution manager module 147, or the intelligent service module 149 may be implemented by the processor 150. The function of the intelligent agent 145, the execution manager module 147, or the intelligent service module 149 will be described as the operation of the processor 150. According to an embodiment, the intelligent agent 145, the execution manager module 147, or the intelligent service module 149 stored in the memory 140 may be implemented not only as software but also as hardware.

According to an embodiment, the processor 150 may control the overall operation of the UE 100. For example, the processor 150 may receive user input by controlling the input module 110. The processor 150 may display an image by controlling the display 120. The processor 150 may output a voice signal by controlling the speaker 130. The processor 150 may execute a program and load or store required information by controlling the memory 140.

According to an embodiment, the processor 150 may execute the intelligent agent 145, the execution manager module 147, or the intelligent service module 149 stored in the memory 140. Accordingly, the processor 150 may implement the function of the intelligent agent 145, the execution manager module 147, or the intelligent service module 149.

According to an embodiment, the processor 150 may generate a command for executing an app on the basis of a voice signal received as user input by executing the intelligent agent 145. According to an embodiment, the processor 150 may execute the apps 141 and 143 stored in the memory 140 according to the generated command by executing the execution manager module 147. According to an embodiment, the processor 150 may manage user information by executing the intelligent service module 149 and process user input on the basis of the user information.

The processor 150 may transmit the user input received through the input module 110 to the intelligent server 200 by executing the intelligent agent 145 and process the user input through the intelligent server 200.

According to an embodiment, the processor 150 may preprocess the user input before transmitting the user input to the intelligent server 200 by executing the intelligent agent 145. According to an embodiment, in order to preprocess the user input, the intelligent agent 145 may include an Adaptive Echo Canceller (AEC) module, a Noise Suppression (NS) module, an End-Point Detection (EPD) module, or an Automatic Gain Control (AGC) module. The AEC may remove an echo from the user input. The NS module may suppress background noise included in the user input. The EPD module may detect the end of a user voice included in the user input and find a part in which the user voice exists on the basis of the detected end. The AGC module may recognize the user input and adjust the volume of the user input in order to properly process the recognized user input. The processor 150 may execute all of the preprocessing configurations for the performance according to an embodiment, but the processor 150 may execute only some of the preprocessing configurations to operate with low power according to another embodiment.

According to an embodiment, the intelligent agent 145 may execute a wake-up recognition module stored in the memory 140 to recognize a user call. Accordingly, the processor 150 may recognize a user's wake-up command through the wake-up recognition module and, when the wake-up command is received, execute the intelligent agent 145 for receiving the user input. The wake-up recognition module may be implemented as a low-power processor (for example, a processor included in an audio codec). According to an embodiment, the processor 150 may execute the intelligent agent 145 when receiving the user input through a hardware key. When the intelligent agent 145 is executed, an intelligent app (for example, a voice recognition app) linked to the intelligent agent 145 may be executed.

According to an embodiment, the intelligent agent 145 may include a voice recognition module for executing the user input. The processor 150 may recognize the user input for performing the operation in the app through the voice recognition module. For example, the processor 150 may recognize a limited user (voice) input (for example, an utterance such as “click” for performing a capture operation when a camera app is being executed) for performing the operation such as the wake-up command in the apps 141 and 143 through the voice recognition module. The processor 150 may assist the intelligent server 200 in recognizing and rapidly processing a user command that can be processed within the UE 100 through the voice recognition module. According to an embodiment, the voice recognition module of the intelligent agent 145 for executing the user input may be implemented by an app processor.

According to an embodiment, the voice recognition module of the intelligent agent 145 (including the voice recognition module of the wake-up module) may receive the user input through an algorithm for recognizing a voice. The algorithm used for recognizing the voice may be at least one of, for example, a Hidden Markov Model (HMM) algorithm, an Artificial Neural Network (ANN) algorithm, or a Dynamic Time Warping (DTW) algorithm.

According to an embodiment, the processor 150 may convert a user voice input into text data by executing the intelligent agent 145. For example, the processor 150 may transmit the user voice to the intelligent server 200 through the intelligent agent 145 and receive text data corresponding to the user voice from the intelligent server 200. Accordingly, the processor 150 may display the converted text data on the display 120.

According to an embodiment, the processor 150 may receive a path rule from the intelligent server 200 by executing the intelligent agent 145. According to an embodiment, the processor 150 may transmit the path rule to the execution manager module 147 through the intelligent agent 145.

According to an embodiment, the processor 150 may transmit an execution result log according to the path rule received from the intelligent server 200 to the intelligent service module 149 by executing the intelligent agent 145, and the transmitted execution result log may be accumulated in user preference information of the persona module (persona manager) 149b and managed.

According to an embodiment, the processor 150 may receive the path rule from the intelligent agent 145 by executing the execution manager module 147, execute the apps 141 and 143, and allow the apps 141 and 143 to perform the operations 141b and 143b included in the path rule. For example, the processor 150 may transmit command information (for example, path rule information) for performing the operations 141b and 143b by the apps 141 and 143 through the execution manager module 147 and receive completion information of the operations 141b and 143b from the apps 141 and 143.

According to an embodiment, the processor 150 may transmit command information (for example, path rule information) for performing the operations 141b and 143b of the apps 141 and 143 between the intelligent agent 145 and the apps 141 and 143 by executing the execution manager module 147. The processor 150 may bind the apps 141 and 143 to be executed according to the path rule through the execution manager module 147 and transmit command information (for example, path rule information) of the operations 141b and 143b included in the path rule to the apps 141 and 143. For example, the processor 150 may sequentially transmit the operations 141b and 143b included in the path rule to the apps 141 and 143 through the execution manager module 147 and sequentially perform the operations 141b and 143b of the apps 141 and 143 according to the path rule.

According to an embodiment, the processor 150 may manage execution states of the operations 141b and 143b of the apps 141 and 143 by executing the execution manager module 147. For example, the processor 150 may receive information on the execution states of the operations 141b and 143b from the apps 141 and 143 through the execution manager module 147. When the execution states of the operations 141b and 143b are, for example, stopped states (partial landing) (for example, when a parameter required for the operations 141b and 143b is not input), the processor 150 may transmit information on the stopped states to the intelligent agent 145 through the execution manager module 147. The processor 150 may make a request for input of information (for example, parameter information) required for the user on the basis of the received information through the intelligent agent 145. When the execution states of the operations 141b and 143b are, for example, the operation state, the processor 150 may receive a user utterance through the intelligent agent 145. The processor 150 may transmit information on the apps 141 and 143 being executed and information on the execution states of the apps 141 and 143 to the intelligent agent 145 through the execution manager module 147. The processor 150 may transmit the user utterance to the intelligent server 200 through the intelligent agent 145. The processor 150 may receive parameter information of the user utterance from the intelligent server 200 through the intelligent agent 145. The processor 150 may transmit the received parameter information to the execution manager module 147 through the intelligent agent 145. The execution manager module 147 may change the parameter of the operations 141b and 143b to a new parameter on the basis of the received parameter information.

According to an embodiment, the processor 150 may transmit parameter information included in the path rule to the apps 141 and 143 by executing the execution manager module 147. When the plurality of apps 141 and 143 is sequentially executed according to the path rule, the execution manager module 147 may transfer parameter information included in the path rule from one app to another app.

According to an embodiment, the processor 150 may receive a plurality of path rules by executing the execution manager module 147. The processor 150 may select a plurality of path rules on the basis of the user utterance through the execution manager module 147. For example, the user utterance specifies the app 141 to perform the operation 141a through the execution manager module 147, but if another app 143 to perform the remaining operation 143b is not specified, the processor 150 may receive a plurality of different path rules for executing the same app 141 (for example, a gallery app) to perform the operation 141a and executing the other app 143 (for example, a message app or a telegram app) to perform the remaining operation 143b. The processor 150 may perform the same operations 141b and 143b of the plurality of path rules (for example, the same successive operations 141b and 143b) through, for example, the execution manager module 147. When the processor 150 completes execution of the same operation, the processor 150 may display a state screen for selecting different apps 141 and 143 included in the plurality of path rules on the display 120 through the execution manager module 147.

According to an embodiment, the intelligent service module 149 may include a context module 149a, a persona module 149b, or a proposal module 149c.

The processor 150 may collect current states of the apps 141 and 143 from the apps 141 and 143 by executing the context module 149a. For example, the processor 150 may receive context information indicating the current states of the apps 141 and 143 by executing the context module 149a and collect the current states of the apps 141 and 143 through the received context information.

The processor 150 may manage personal information of the user using the UE 100 by executing the persona module 149b. For example, the processor 150 may collect usage information and the performance result of the UE 100 by executing the persona module 149b and manage personal information of the user on the basis of the collected usage information and performance result of the UE 100.

The processor 150 may predict a user's intent by executing the proposal module 149c and recommend a command to the user on the basis of the user's intent. For example, the processor 150 may recommend a command to the user according to the current state of the user (for example, the time, location, situation, and apps) by executing the proposal module 149c.

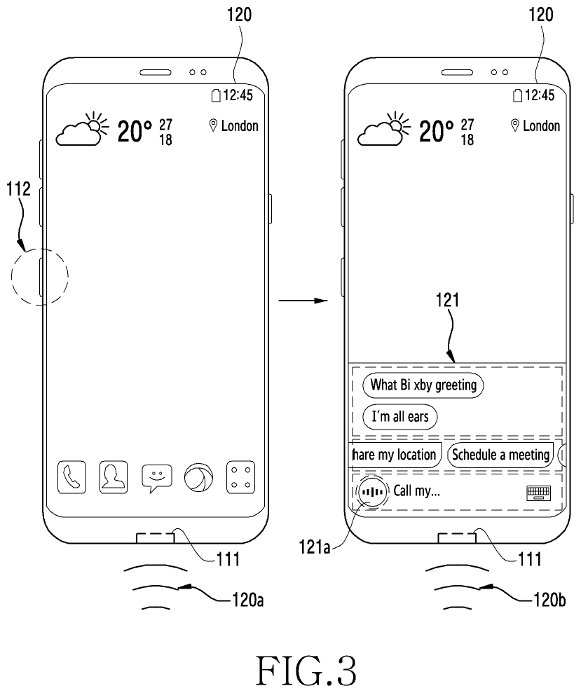

FIG. 3 illustrates execution of an intelligent app of a UE according to an embodiment of the disclosure.

Referring to FIG. 3, the UE 100 receives user input and executes an intelligent app (for example, a voice recognition app) linked to the intelligent agent 145.

According to an embodiment, the UE 100 may execute an intelligent app for recognizing a voice through a hardware key 112. For example, when receiving the user input through the hardware key 112, the UE 100 may display a User Interface (UI) 121 of the intelligent app on the display 120. The user may touch a voice recognition button 121a on the UI 121 of the intelligent app in order to input a voice, as indicated by reference numeral 111b, in the state in which the UI 121 of the intelligent app is displayed on the display 120. In another example, the user may input a voice as indicated by reference numeral 120b by continuously pressing the hardware key 112 in order to input the voice 120b.

According to an embodiment, the UE 100 may execute the intelligent app for recognizing the voice through the microphone 111. For example, when a predetermined voice (for example, “wake up!”) is input through the microphone 111, as indicated by reference numeral 111a, the UE 100 may display the UI 121 of the intelligent app on the display 120.

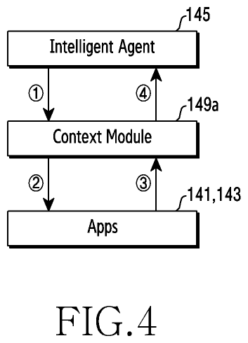

FIG. 4 illustrates collection of a current state by a context module of an intelligent service module according to an embodiment of the disclosure.

Referring to FIG. 4, when receiving a context request from the intelligent agent 145 (\textcircled{1}), the processor 150 may make a request for context information indicating the current state of the apps 141 and 143 through the context module 149a (\textcircled{2}). According to an embodiment, the processor 150 may receive the context information from the apps 141 and 143 through the context module 149a (\textcircled{3}) and transmit the context information to the intelligent agent 145 (\textcircled{4}).

According to an embodiment, the processor 150 may receive a plurality of pieces of context information from the apps 141 and 143 through the context module 149a. The context information may be, for example, information on the most recently executed apps 141 and 143. In another example, the context information may be information on the current state within the apps 141 and 143 (for example, information on a corresponding photo when the photo is viewed in a gallery).

According to an embodiment, the processor 150 may receive not only the apps 141 and 143 but also context information indicating the current state of the UE 100 from a device platform through the context module 149a. The context information may include general context information, user context information, or device context information.

The general context information may include general information of the UE 100. The general context information may be identified through an internal algorithm after data is received through a sensor hub of a device platform. For example, the general context information may include information on the current time and location. Information on the current time and location may include, for example, the current time or information on the current location of the UE 100. The current time may be identified through the time on the UE 100, and the information on the current location may be identified through a Global Positioning System (GPS). In another example, the general context information may include information on physical movement. The information on physical movement may include, for example, information on walking, running, and driving. The physical movement information may be identified through a motion sensor. With regard to information on driving, movement may be identified through the motion sensor, and additionally, riding and parking may be identified through detection of a Bluetooth connection within the vehicle. In another example, the general context information may include user activity information. The user activity information may include, for example, information on commuting, shopping, and travel. The user activity information may be identified using information on a place registered in a database by the user or the app.

The user context information may include information on the user. For example, the user context information may include information on the emotional state of the user. The information on the emotional state may include, for example, information on happiness, sadness, and anger of the user. In another example, the user context information may include information on the current state of the user. The information on the current state may include, for example, information on interest, intent, and the like (for example, shopping).

The device context information may include information on the state of the UE 100. For example, the device context information may include information on a path rule executed by the execution manager module 147. In another example, the device information may include information on a battery. The information on the battery may be identified through, for example, a charging and discharging state of the battery. In another example, the device information may include information on a connected device and network. The information on the connected device may be identified through, for example, a communication interface to which the device is connected.

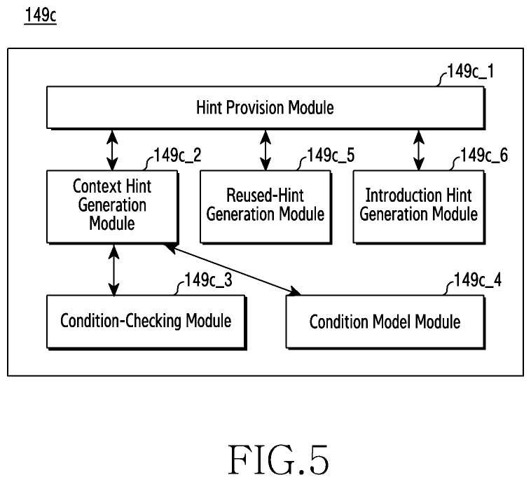

FIG. 5 is a block diagram illustrating a proposal module of an intelligent service module according to an embodiment of the disclosure.

Referring to FIG. 5, the proposal module 149c may include a hint provision module 149c_1, a context hint generation module 149c_2, a condition-checking module 149c_3, a condition model module 149c_4, a reused-hint generation module 149c_5, or an introduction hint generation module 149c_6.

According to an embodiment, the processor 150 may provide a hint to the user by executing the hint provision module 149c_1. For example, the processor 150 may receive a generated hint from the context hint generation module 149c_2, the reused-hint generation module 149c_5, or an introduction hint generation module 149c_6 through the hint provision module 149c_1 and provide the hint to the user.

According to an embodiment, the processor 150 may generate a hint that can be recommended according to the current state by executing the condition-checking module 149c_3 or the condition model module 149c_4. The processor 150 may receive information corresponding to the current state by executing the condition-checking module 149c_3 and configure a condition model on the basis of the received information by executing the condition model module 149c_4. For example, the processor 150 may detect a time, a location, a situation, and a used app at the time point at which the hint is provided to the user by executing the condition model module 149c_4 and provide hints having a higher use possibility under the corresponding condition to the user having a higher priority.

According to an embodiment, the processor 150 may generate a hint that can be recommended according to a use frequency by executing the reused-hint generation module 149c_5. For example, the processor 150 may generate a hint based on a use pattern of the user by executing the reused-hint generation module 149c_5.

According to an embodiment, the introduction hint generation module 149c_6 may generate a hint for introducing a new function or a function frequently used by another user to the user. For example, the hint for introducing the new function may include introduction (for example, an operation method) of the intelligent agent 145.

According to another embodiment, the context hint generation module 149c_2, the condition-checking module 149c_3, the condition model module 149c_4, the reused-hint generation module 149c_5, or the introduction hint generation module 149c_6 of the proposal module 149c may be included in a personal information server 300. For example, the processor 150 may receive a hint from the context hint generation module 149c_2, the reused-hint generation module 149c_5, or the introduction hint generation module 149c_6 of the personal information server 300 of the user through the hint provision module 149c_1 of the proposal module 149c and provide the received hint to the user.

According to an embodiment, the UE 100 may provide the hint according to a series of processes described below. For example, when receiving a hint provision request from the intelligent agent 145, the processor 150 may transmit a hint generation request to the context hint generation module 149c_2 through the hint provision module 149c_1. When receiving the hint generation request, the processor 150 may receive information corresponding to the current state from the context module 149a and the persona module 149b through the condition-checking module 149c_3. The processor 150 may transmit the information received through the condition-checking module 149c_3 to the condition model module 149c_4 and assign higher priority to a hint having a higher use possibility under the condition, among the hints provided to the user, on the basis of the information through the condition model module 149c_4. The processor 150 may identify the condition through the context hint generation module 149c_2 and generate a hint corresponding to the current state. The processor 150 may transmit the hint generated through the context hint generation module 149c_2 to the hint provision module 149c_1. The processor 150 may arrange the hints according to a predetermined rule through the hint provision module 149c-_1 and transmit the hints to the intelligent agent 145.

According to an embodiment, the processor 150 may generate a plurality of context hints through the hint provision module 149c_1 and designate priorities to the plurality of context hints according a predetermined rule. According to an embodiment, the processor 150 may preferentially provide a hint having a higher priority, among the plurality of context hints, to the user through the hint provision module 149c_1.

According to an embodiment, the UE 100 may propose a hint according to a use frequency. For example, when receiving a hint provision request from the intelligent agent 145, the processor 150 may transmit a hint generation request to the reused-hint generation module 149c_5 through the hint provision module 149c_1. When receiving the hint generation request, the processor 150 may receive user information from the persona module 149b through the reused-hint generation module 149c_5. For example, the processor 150 may receive a path rule included in preference information of the user of the persona module 149b, a parameter included in the path rule, an execution frequency of an app, and time and location information of the used app through the reused-hint generation module 149c_5. The processor 150 may generate a hint corresponding to the received user information through the reused-hint generation module 149c_5. The processor 150 may transmit the hint generated through the reused-hint generation module 149c_5 to the hint provision module 149c_1. The processor 150 may arrange the hints through the hint provision module 149c_1 and transmit the hints to the intelligent agent 145.

According to an embodiment, the UE 100 may propose hints for a new function. For example, when receiving a hint provision request from the intelligent agent 145, the processor 150 may transmit a hint generation request to the introduction hint generation module 149c_6 through the hint provision module 149c_1. The processor 150 may transmit an introduction hint provision request from the proposal server 400 through the introduction hint generation module 149c_6 and receive information on a function to be introduced from the proposal server 400. The proposal server 400 may store, for example, the information on the function to be introduced, and a hint list of functions to be introduced may be updated by a service operator. The processor 150 may transmit the hint generated through the introduction hint generation module 149c_6 to the hint provision module 149c_1. The processor 150 may arrange the hints through the hint provision module 149c_1 and transmit the hints to the intelligent agent 145 (\textcircled{6}).

Accordingly, the processor 150 may provide the hints generated by the context hint generation module 149c_2, the reused-hint generation module 149c_5, or the introduction hint generation module 149c_6 to the user through the proposal module 149c. For example, the processor 150 may display the generated hint on an app for operating the intelligent agent 145 through the proposal module 149c and receive input for selecting the hints from the user through the app.

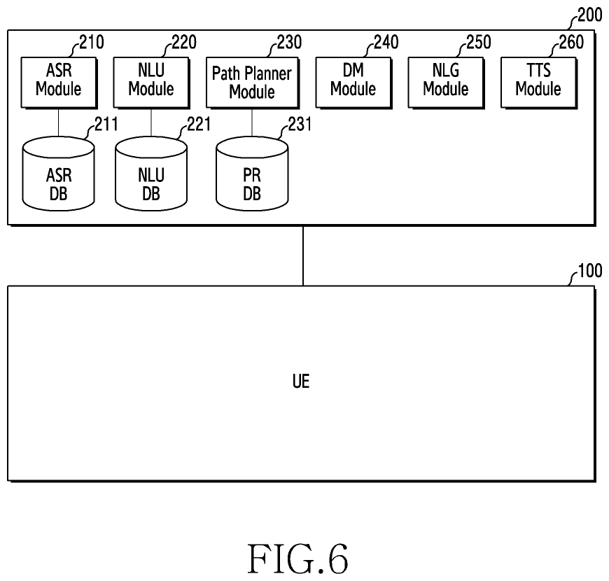

FIG. 6 is a block diagram illustrating an intelligent server of an integrated intelligence system according to an embodiment of the disclosure.

Referring to FIG. 6, the intelligence server 200 may include an Automatic Speech Recognition (ASR) module 210, a Natural Language Understanding (NLU) module 220, a path planner module 230, a Dialogue Manager (DM) module 240, a Natural Language Generator (NLG) module 250, or a Text-To-Speech (TTS) module 260. According to an embodiment, the intelligent server 200 may include a communication circuit, a memory, and a processor. The processor may drive the ASR module 210, the NLU module 220, the path planner module 230, the DM module 240, the NLG module 250, and the TTS module 260 by executing an instruction stored in the memory. The intelligent server 200 may transmit and receive data (or information) to and from an external electronic device (for example, the UE 100) through the communication circuit.

The NLU module 220 or the path planner module 230 of the intelligent server 200 may generate a path rule.

According to an embodiment, the ASR module 210 may convert user input received from the UE 110 into text data.

According to an embodiment, the ASR module 210 may convert the user input received from the UE 100 into text data. For example, the ASR module 210 may include an utterance recognition module. The utterance recognition module may include an acoustic model and a language model. For example, the acoustic model may include information related to vocalization, and the language model may include information on unit phoneme information and a combination of unit phoneme information. The utterance recognition module may convert a user utterance into text data on the basis of information related to vocalization and information on unit phoneme information. Information on the acoustic model and the language model may be stored in, for example, an Automatic Speech Recognition Database (ASR DB) 211.

According to an embodiment, the NLU module 220 may detect a user's intent by performing syntactic analysis or semantic analysis. The syntactic analysis may divide the user input into syntactic units (for example, words, phrases, or morphemes) and may detect which syntactic element belongs to each of the units resulting from the division. The semantic analysis may be performed using semantic matching, rule matching, or formula matching. Accordingly, the NLU module 220 may acquire a domain and an intent of the user input, or a parameter (or a slot) required for expressing the intent.

According to an embodiment, the NLU module 220 may determine a user's intent and a parameter using a matching rule divided into the domain, the intent, and the parameter (or slot) required for detecting the intent. For example, one domain (for example, an alarm) may include a plurality of intents (for example, alarm setting or alarm release), and one intent may include a plurality of parameters (for example, a time, a number of repetitions, and an alarm sound). A plurality of rules may include, for example, one or more necessary element parameters. The matching rule may be stored in a Natural Language Understanding Database (NLU DB) 221.

According to an embodiment, the LNU module 220 may detect the meaning of a word extracted from the user input on the basis of linguistic features (for example, syntactic elements) such as morphemes or phrases and determine a user's intent by matching the detected meaning of the word with a domain and an intent. For example, the NLU module 220 may determine the user's intent by identifying how many times each word extracted from the user input is included in each domain and each intent. According to an embodiment, the NLU module 220 may determine a parameter of the user input through the word, which is the basis of detecting the intent. According to an embodiment, the NLU module 220 may determine the user's intent through the NLU DB 221 storing linguistic features for detecting the intent of the user input. According to another embodiment, the NLU module 220 may determine the user's intent through a Personal Language Model (PLM). For example, the NLU module 220 may determine the user's intent on the basis of personalized information (for example, a contact list or a music list). The personalized language model may be stored in, for example, the NLU DB 221. According to an embodiment, not only the NLU module 220 but also the ASR module 210 may recognize a user's voice with reference to the personal language model stored in the NLU DB 221.

According to an embodiment, the NLU module 220 may generate a path rule on the basis of the intent and the parameter of the user input. For example, the NLU module 220 may select an app to be executed on the basis of the intent of the user input and determine an operation to be performed by the selected app. The NLU module 220 may generate a path rule by determining a parameter corresponding to the determined operation. According to an embodiment, the path rule generated by the NLU module 220 may include an app to be executed, an operation to be performed by the app (for example, at least one state), and information on a parameter required for performing the operation.

According to an embodiment, the NLU module 220 may generate one path rule or a plurality of path rules on the basis of the intent and the parameter of the user input. For example, the NLU module 220 may receive a path rule set corresponding to the UE 100 from the path planner module 230 and map the intent and the parameter of the user input to the received path rule set, so as to determine a path rule.

According to another embodiment, the NLU module 220 may determine an app to be executed on the basis of the intent and the parameter of the user input, an operation to be executed by the app, and a parameter required for performing the operation, and generate one path rule or a plurality of path rules. For example, the NLU module 220 may generate a path rule by arranging the app to be executed and the operation to be executed by the app in the form of an ontological or graphical model according to the intent of the user input on the basis of information on the UE 100. The generated path rule may be stored in a Path Rule Database (PR DB) 231 through, for example, the path planner module 230. The generated path rule may be added to the path rule set of the database 231.

According to an embodiment, the NLU module 220 may select at least one path rule from the plurality of generated path rules. For example, the NLU module 220 may select an optimal path rule from the plurality of path rules. In another example, when only some operations are specified, the NLU module 220 may select a plurality of path rules on the basis of a user utterance. The NLU module 220 may determine one path rule from the plurality of path rules based on additional user input.

According to an embodiment, the NLU module 220 may transmit a path rule to the UE 100 in response to a request for the user input. For example, the NLU module 220 may transmit one path rule corresponding to the user input to the UE 100. In another example, the NLU module 220 may transmit a plurality of path rules corresponding to the user input to the UE 100. When only some operations are specified on the basis of a user utterance, the plurality of path rules may be generated by the NLU module 220.

According to an embodiment, the path planner module 230 may select at least one path rule from the plurality of path rules.

According to an embodiment, the path planner module 230 may transmit a path rule set including a plurality of path rules to the NLU module 220. The plurality of path rules included in the path rule set may be stored in the path rule database 231 connected to the path planner module 230 in the form of a table. For example, the path planner module 230 may transmit a path rule set corresponding to information on the UE 100 (for example, OS information and app information) received from the intelligent agent 145 to the NLU module 220. For example, the table stored in the path rule database 231 may be stored for each domain or each version of the domain.

According to an embodiment, the path planner module 230 may select one path rule or a plurality of path rules from the path rule set, and transmit the selected path rule or path rules to the NLU module 220.

For example, the path planner module 230 may match a user's intent and a parameter to a path rule set corresponding to the UE 100, select one path rule or a plurality of path rules, and transmit the selected path rule or path rules to the NLU module 220.

According to an embodiment, the path planner module 230 may generate one path rule or a plurality of path rules on the basis of the user's intent and the parameter. For example, the path planner module 230 may determine an app to be executed on the basis of the user's intent and the parameter and an operation to be executed by the app, and generate one path rule or a plurality of path rules. According to an embodiment, the path planner module 230 may store the generated path rule in the path rule database 231.

According to an embodiment, the path planner module 230 may store the path rule generated by the NLU module 220 in the path rule database 231. The generated path rule may be added to the path rule set stored in the path rule database 231.

According to an embodiment, the table stored in the path rule database 231 may include a plurality of path rules or a plurality of path rule sets. The plurality of path rules or the plurality of path rule sets may reflect the kind, version, type, or characteristics of the device performing each path rule.

According to an embodiment, the DM module 240 may determine whether the user's intent detected by the NLU module 220 is clear. For example, the DM module 240 may determine whether the user's intent is clear on the basis of whether parameter information is sufficient. The DM module 240 may determine whether the parameter detected by the NLU module 220 is sufficient to perform a task. According to an embodiment, when the user's intent is not clear, the DM module 240 may transmit feedback making a request for required information to the user. For example, the DM module 240 may transmit feedback making a request for information on the parameter for detecting the user's intent.

According to an embodiment, the DM module 240 may include a content provider module. When the operation can be performed on the basis of the intent and the parameter detected by the NLU module 220, the content provider module may generate the result of the task corresponding to the user input. According to an embodiment, the DM module 240 may transmit the result generated by the content provider module to the UE 100 in response to the user input.

According to an embodiment, the NLG module 250 may convert predetermined information into the form of text. The information converted into the form of text may take the form of natural language speech. The predetermined information may be, for example, information on additional input, information indicating completion of an operation corresponding to user input, or information indicating additional user input (for example, feedback information of user input). The information converted into the form of text may be transmitted to the UE 100 and displayed on the display 120, or may be transmitted to the TTS module 260 and converted into voice form.

According to an embodiment, the TTS module 260 may convert information in the text form into information in voice form. The TTS module 260 may receive information in the text form from the NLG module 250, convert the information in text form into information in voice form, and transmit the information to the UE 100. The UE 100 may output the information in the voice form to the speaker 130.

According to an embodiment, the NLU module 220, the path planner module 230, and the DM module 240 may be implemented as a single module. For example, the NLU module 220, the path planner module 230, and the DM module 240 may be implemented as a single module to determine a user's intent and a parameter and generate a response (for example, a path rule) corresponding to the determined user's intent and parameter. Accordingly, the generated response may be transmitted to the UE 100.

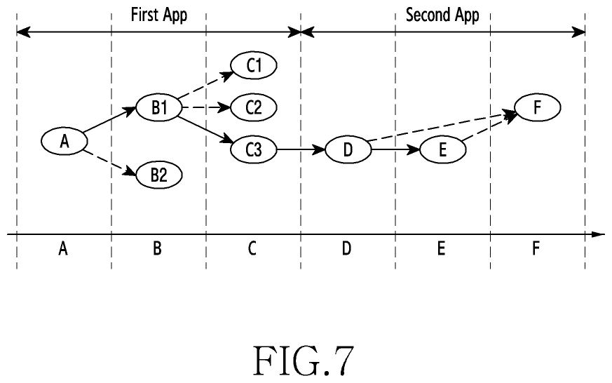

FIG. 7 illustrates a method of generating a path rule of a path planner module according to an embodiment of the disclosure.

Referring to FIG. 7, the NLU module 220 according to an embodiment may classify the function of an app by one operation (for example, one of states A to F) and store the same in the path rule database 231. For example, the NLU module 220 may store a path rule set including a plurality of path rules (A-B1-C1, A-B1-C2, A-B1-C3-D-F, and A-B1-C3-D-E-F) classified by one operation (for example, the state) in the path rule database 231.

According to an embodiment, the path rule database 231 of the path planner module 230 may store a path rule set for performing the function of the app. The path rule set may include a plurality of path rules including a plurality of operations (for example, a sequence of states). In the plurality of path rules, operations executed by parameter input into each of a plurality of operations may be sequentially arranged. According to an embodiment, the plurality of path rules may be configured in the form of an ontological or graphical model and stored in the path rule database 231.

According to an embodiment, the NLU module 220 may select an optimal path rule (A-B1-C3-D-F) from the plurality of path rules (A-B1-C1, A-B1-C2, A-B1-C3-D-F, and A-B1-C3-D-E-F) corresponding to the intent and the parameter of the user input.

According to an embodiment, when there is no path rule that completely matches the user input, the NLU module 220 may transmit a plurality of rules to the UE 100. For example, the NLU module 220 may select a path rule (for example, A-B1) partially corresponding to the user input. The NLU module 220 may select one or more path rules (for example, A-B1-C1, A-B1-C2, A-B1-C3-D-F, and A-B1-C3-D-E-F) including the path rule (for example, A-B1) partially corresponding to the user input and transmit the one or more path rules to the UE 100.

According to an embodiment, the NLU module 220 may select one of the plurality of path rules on the basis of additional input via the UE 100 and transmit the selected one path rule to the UE 100. For example, the NLU module 220 may select one path rule (for example, A-B1-C3-D-F) from the plurality of path rules (for example, A-B1-C1, A-B1-C2, A-B1-C3-D-F, A-B1-C3-D-E-F) according to user input (for example, input for selecting C3) additionally made by the UE 100 and transmit the one selected path rule to the UE 100.

According to another embodiment, the NLU module 220 may determine a user's intent and a parameter corresponding to the user input (for example, input for selecting C3) additionally made by the UE 100 through the NLU module 220 and transmit the determined user's intent or parameter to the UE 100. The UE 100 may select one path rule (for example, A-B1-C3-D-F) from the plurality of path rules (for example, A-B1-C1, A-B1-C2, A-B1-C3-D-F, and A-B1-C3-D-E-F) on the basis of the transmitted intent or parameter.

Accordingly, the UE 100 may complete the operation of the apps 141 and 143 by the one selected path rule.

According to an embodiment, when a user input having insufficient information is received by the intelligent server 200, the NLU module 220 may generate a path rule partially corresponding to the received user input. For example, the NLU module 220 may transmit the partially corresponding path rule to the intelligent agent 145. The processor 150 may execute the intelligent agent 145 to receive the path rule and transmit the partially corresponding path rule to the execution manager module 147. The processor 150 may execute the first app 141 according to the path rule through the execution manager module 147. The processor 150 may transmit information on an insufficient parameter to the intelligent agent 145 while executing the first app 141 through the execution manager module 147. The processor 150 may make a request for additional input to the user on the basis of the information on the insufficient parameter through the intelligent agent 145. When the additional input is received from the user through the intelligent agent 145, the processor 150 may transmit the user input to the intelligent server 200 and process the same. The NLU module 220 may generate an additional path rule on the basis of an intent and parameter information of the additionally made user input and transmit the path rule to the intelligent agent 145. The processor 150 may transmit the path rule to the execution manager module 147 through the intelligent agent 145 and execute the second app 143.

According to an embodiment, when user input from which some information is omitted is received by the intelligent server 200, the NLU module 220 may transmit a user information request to the personal information server 300. The personal information server 300 may transmit information on the user who made the user input stored in the persona database to the NLU module 220. The NLU module 220 may select a path rule corresponding to user input from which some operations are omitted on the basis of the user information. Accordingly, although the user input from which some information is omitted is received by the intelligent agent 200, the NLU module 220 may receive additional input by making a request for omitted information, or may determine a path rule corresponding to the user input on the basis of the user information.

[Table 1] below shows an example of a path rule related to a task requested from the user according to an embodiment.

TABLE 1

| Path rule ID | State | parameter |
|---|---|---|
| Gallery_101 | pictureView (25) | NULL |
| | searchView (26) | NULL |
| | searchViewResult (27) | Location, time |
| | SearchEmptySelectedView (28) | NULL |
| | SearchSelectedView (29) | ContentType, |
| | | selectall |
| | CrossShare (30) | anaphora |

Referring to [Table 1], a path rule generated or selected by an intelligent server (the intelligent server 200 of FIG. 1) according to a user utterance (for example, “share pictures”) may include at least one state 25, 26, 27, 28, 29, or 30. For example, at least one state (for example, at least one operation state of the UE) may correspond to at least one of executing a picture application (PicturesView) 25, executing a picture search function (SearchView) 26, outputting a search result on a display screen (SearchViewResult) 27, outputting a search result obtained by non-selection of a picture on a display screen (SearchEmptySelectedView) 28, outputting a search result obtained by selection of at least one picture on a display screen (SearchSelectedView) 29, or outputting a shared application selection screen (CrossShare) 30.

According to an embodiment, parameter information of the path rule may correspond to at least one state. For example, parameter information of the path rule may be included in the state 29 of outputting a search result, obtained through selection of at least one picture on a display screen.

As a result of the path rule including the sequence of the states 25, 26, 27, 28, and 29, a task requested from the user (for example, “share pictures!”) may be conducted.

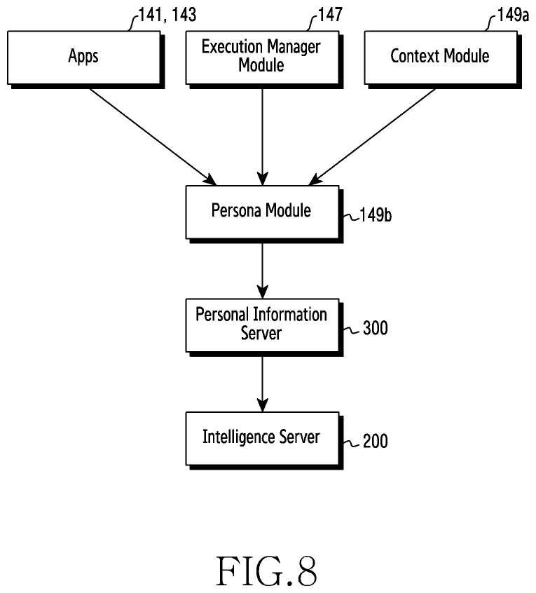

FIG. 8 illustrates management of user information by a persona module of an intelligence service module according to an embodiment of the disclosure.

Referring to FIG. 8, the processor 150 may receive information on the UE 100 from the apps 141 and 143, the execution manager module 147, or the context module 149a through the persona module 149b. The processor 150 may store information on the apps 141 and 143 and on the result of execution of the operations 141b and 143b of the apps through the execution manager module 147 in an operation log database. The processor 150 may store information on the current state of the UE 100 in a context database through the context module 149a. The processor 150 may receive the stored information from the operation log database or the context database through the persona module 149b. The data stored in the operation log database and the context database may be analyzed using, for example, an analysis engine, and may be transmitted to the persona module 149b.

According to an embodiment, the processor 150 may transmit information received from the apps 141 and 143, the execution manager module 147, or the context module 149a to the proposal module 149c through the persona module 149b. For example, the processor 150 may transmit the data stored in the operation log database or the context database to the proposal module 149c through the persona module 149b.

According to an embodiment, the processor 150 may transmit information received from the apps 141 and 143, the execution manager module 147, or the context module 149a to the personal information server 300 through the persona module 149b. For example, the processor 150 may periodically transmit data accumulated and stored in the operation log database or the context database to the personal information server 300 through the persona module 149b.

According to an embodiment, the processor 150 may transmit data stored in the operation log database or the context database to the proposal module 149c through the persona module 149b. User information generated through the persona module 149b may be stored in a persona database. The persona module 149b may periodically transmit user information stored in the persona database to the personal information server 300. According to an embodiment, the information transmitted to the personal information server 300 through the persona module 149b may be stored in the persona database. The personal information server 300 may infer user information required for generating the path rule of the intelligent server 200 on the basis of the information stored in the persona database.

According to an embodiment, the user information inferred using the information transmitted through the persona module 149b may include profile information or preference information. The profile information or preference information may be inferred through a user account and accumulated information.

The profile information may include personal information on the user. For example, the profile information may include demographic information of the user. The demographic information may include, for example, the gender and age of the user. In another example, the profile information may include life event information. The life event information may be inferred through, for example, comparison between log information and a life event model, and may be reinforced through analysis of behavior patterns. In another example, the profile information may include interest information. The interest information may include, for example, shopping items of interest and fields of interest (for example, sports and politics). In another example, the profile information may include activity region information. The activity region information may include, for example, information on home and a workplace. The activity region information may include not only information on the location of a place but also information on regions of which priorities are recorded according to an accumulated stay time and the number of visits. In another example, the profile information may include activity time information. The activity time information may include, for example, the wakeup time, a commuting time, and sleeping hours. The information on the commuting time may be inferred using the activity region information (for example, information on the home and the workplace). The information on the sleeping hours may be inferred based on the time during which the UE 100 is not used.

The preference information may include user preference information. For example, the preference information may include information on app preferences. The app preferences may be inferred through, for example, a usage history of an app (for example, a usage history every hour or at respective locations). The app preference may be used to determine an app to be executed according to the current state of the user (for example, the time or location thereof). In another example, the preference information may include information on contact preferences. The contact preferences may be inferred through, for example, analysis of information on a contact frequency of contact information (for example, a frequency of contacts every hour or at respective locations). The contact preference may be used to determine contact information to contact according to the current state of the user (for example, contacts with duplicate names). In another example, the preference information may include setting information. The setting information may be inferred analyzing information on a setting frequency of a specific setting value (for example, a frequency of a setting value every hour or at respective locations). The setting information may be used to configure a specific setting value according to the current state of the user (for example, the time, place, and situation). In another example, the preference information may include a place preference. The place preference may be inferred through, for example, a history of visits to a specific place (for example, a visit history every hour). The place preference may be used to determine the place that the user visits according to the current state of the user (for example, the time). In another example, the preference information may include command preferences. The command preferences may be inferred through, for example, a command use frequency (for example, a use frequency every hour or at respective locations). The command preference may be used to determine a command pattern to be used according to the current state of the user (for example, the time or place). Specifically, the command preference may include information on the menu item that the user most frequency selects in the current state of an app being executed through analysis of log information.

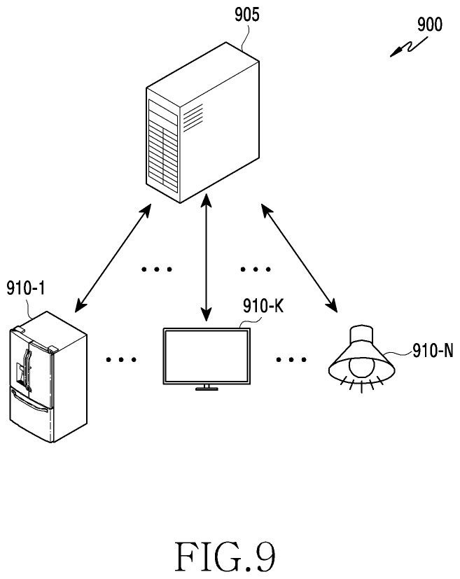

FIG. 9 illustrates an example of an environment including a plurality of electronic devices according to various embodiments.

An environment 900 may include a server 905 and a plurality of electronic devices (for example, electronic devices 910-1 to 910-N).

The server 905 may communicate with the plurality of electronic devices (for example, the electronic devices 910-1 to 910-N).

According to various embodiments, the server 905 may receive data, signals, information, or messages from at least some of the plurality of electronic devices (for example, the electronic devices 910-1 to 910-N).

The server 905 may receive the data, signals, information, or messages related to a voice signal received by at least some of the plurality of electronic devices from at least some of the plurality of electronic devices. The data, signals, information, or messages may be directly received by the server 905 from at least some of the plurality of electronic devices. The data, signals, information, or messages may be received by the server 905 through at least one other device selected from among the at least some of the plurality of electronic devices.

According to various embodiments, the server 905 may transmit data, signals, information, or messages to at least some of the plurality of electronic devices (for example, the electronic devices 910-1 to 910-N). The server 905 may transmit data, signals, information, or messages related to a response to or feedback of a voice signal received by at least some of the plurality of electronic devices to at least some of the plurality of electronic devices. The data, signals, information, or messages may be directly transmitted to at least some of the plurality of electronic devices. The data, signals, information, or messages may be transmitted to at least some of the plurality of electronic devices through at least one other device.

According to various embodiments, the server 905 may correspond to at least one of the intelligent server 200, the personal information server 300, and the proposal server 400 illustrated in FIG. 1.

According to various embodiments, the server 905 may be a device linked to at least one of the intelligent server 200, the personal information server 300, and the proposal server 400 illustrated in FIG. 1. For example, the server 905 may communicate with at least one of the intelligent server 200, the personal information server 300, and the proposal server 400 in order to link to at least one of the intelligent server 200, the personal information server 300, and the proposal server 400 illustrated in FIG. 1.

Each of the plurality of electronic devices (for example, the electronic devices 910-1 to 910-N) may provide services. Each of the plurality of electronic devices may provide services on the basis of input received by each of the plurality of electronic devices.

At least some of the plurality of electronic devices (for example, the electronic devices 910-1 to 910-N) may communicate with the server 905. According to various embodiments, at least some of the plurality of electronic devices (for example, the electronic devices 910-1 to 910-N) may transmit data, signals, information, or messages to the server 905. The data, signals, information, or messages provided to the server 905 may be related to a voice signal received by at least some of the plurality of electronic devices. According to various embodiments, at least some of the plurality of electronic devices (for example, the electronic devices 910-1 to 910-N) may receive data, signals, information, or messages from the server 905. The data, signals, information, or messages provided from the server 905 may be related to a response to or feedback of a voice signal received by at least some of the plurality of electronic devices.

At least some of the plurality of electronic devices (for example, the electronic devices 910-1 to 910-N) may communication with at least some remaining ones of the plurality of electronic devices. According to various embodiments, communication between the plurality of electronic devices may be direct communication between devices (Device-to-Device (D2D) such as Bluetooth communication, Bluetooth Low Energy (BLE) communication, Wireless Fidelity (Wi-Fi) direct communication, or Long-Term Evolution (LTE) sidelink communication. According to various embodiments, communication between the plurality of electronic devices may be communication that requires an intermediate node such as an access point, a base station, or a server.

At least some of the plurality of electronic devices (for example, the electronic devices 910-1 to 910-N) may have capabilities, characteristics, or attributes different from at least some other ones among the plurality of electronic devices.

For example, at least some of the plurality of electronic devices (for example, the electronic devices 910-1 to 910-N) may be fixed devices, but at least others of the plurality of electronic devices may be mobile devices. For example, at least some of the plurality of electronic devices may include one or more of a desktop computer, a television (TV), a refrigerator, a washing machine, an air conditioner, a smart light, a Large Format Display (LFD), a digital signage, or a mirror display, and at least others of the plurality of electronic devices may include one or more of a smartphone, a tablet computer, a laptop computer, a portable game device, a portable music player, or a vacuum cleaner.

In another example, at least some of the plurality of electronic devices may perform bidirectional communication (for example, transmission and reception of data, signals, information, or messages) with another device (for example, the server 905), but at least others of the plurality of electronic devices may perform one-way communication with another device.

In another example, at least some of the plurality of electronic devices may be capable of receiving a voice signal, but at least others of the plurality of electronic devices may not be capable of receiving a voice signal.

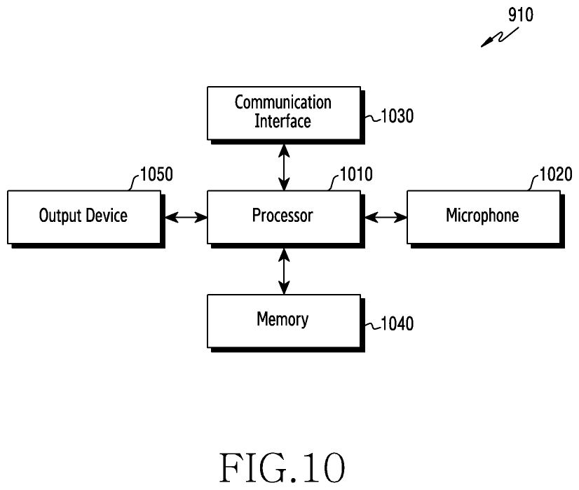

FIG. 10 illustrates an example of the functional configuration of an electronic device performing an operation related to voice recognition according to various embodiments. The functional configuration may be included in at least one of the plurality of electronic devices (electronic devices 910-1 to 910-N) illustrated in FIG. 9.

Referring to FIG. 10, the electronic device 910 may include a processor 1010, a microphone 1020, a communication interface 1030, a memory 1040, and an output device 1050.

The processor 1010 may control the overall operation of the electronic device 910. The processor 1010 may be operatively connected to another element within the electronic device 910, such as the microphone 1020, the communication interface 1030, the memory 1040, or the output device 1050, in order to control the overall operation of the electronic device 910.

The processor 1010 may receive commands of other elements of the electronic device 910, analyze the received commands, and perform calculations or process data according to the analyzed commands.

The processor 1010 may process data or signals generated within the electronic device 910. For example, the processor 1010 may make a request for a command, data, or signal to the memory 1040. The processor 1010 may record (or store) or update the command, data, or signal within the memory 1040 to control the electronic device 910 or control another element within the electronic device 910.

The processor 1010 may analyze and process a message, data, command, or signal received from the microphone 1020, the communication interface 1030, the memory 1040, or the output device 1050. The processor 1010 may generate a new message, data, command, or signal on the basis of the received message, data, command, or signal. The processor 1010 may provide the processed or generated message, data, command, or signal to the microphone 1020, the communication interface 1030, the memory 1040, or the output device 1050.

The processor 1010 may include at least one processor. For example, the processor 1010 may include one or more of an application processor for controlling a program in a higher layer such as an application, a communication processor for controlling a function related to communication, or an audio codec chip for controlling encoding and decoding related to an audio signal.

The microphone 1020 may receive an audio signal generated outside the electronic device 910. The microphone 1020 may receive an audio signal such as a voice signal generated by the user associated with the electronic device 910. The microphone 1020 may convert the received audio signal into an electrical signal. The microphone 1020 may provide the converted electrical signal to the processor 1010.

The communication interface 1030 may be used to generate or establish a communication path between another electronic device and the electronic device 910 (for example, a communication path between the electronic device 910 and another electronic device 910-K or a communication path between the electronic device 910 and the server 905). For example, the communication interface 1030 may be a module for at least one of a Bluetooth communication scheme, a Bluetooth Low Energy (BLE) communication scheme, a Wireless Fidelity (Wi-Fi) communication scheme, a cellular (or mobile) communication scheme, or a wired communication scheme. The communication interface 1030 may provide a signal, information, data, or a message received from another electronic device to the processor 1010. The communication interface 1030 may transmit a signal, information, data, or a message provided from the processor 1010 to another electronic device.

The memory 1040 may store a command, a control command code, control information, or user data for controlling the electronic device 910. For example, the memory 1040 may include an application, an Operating System (OS), middleware, and a device driver.

The output device 1050 may be used to provide information to the user. For example, the output device 1050 may include one or more of a speaker for providing information to the user through an audio signal, a display for providing information to the user through a Graphical User Interface (GUI), and an indicator module for providing information to the user through light (for example, a Light-Emitting Diode (LED) module). The output device 1050 may provide information on the basis of the information, data, or signal provided from the processor 1010.

According to various embodiments, the processor 1010 may receive a voice signal through the microphone 1020. The processor 1010 may receive a voice signal for an interaction between the electronic device 910 and the user through the microphone 1020. The voice signal may also be referred to as a user utterance.

The voice signal may include a wake-up command. The wake-up command may be used to switch the electronic device 910 operating in an inactive state to an active state. The inactive state may indicate a state in which at least one of the functions of the electronic device 910 is deactivated. The inactive state may indicate a state in which at least one of the elements of the electronic device 910 is deactivated. The wake-up command may indicate initiation of interaction between the user and the electronic device 910. The wake-up command may indicate that a voice command is scheduled to be received after the wake-up command. The wake-up command may be voice input used to activate a function for voice recognition of the electronic device 910. The wake-up command may be voice input used to indicate that a voice command that can be received after the wake-up command is a voice signal related to the electronic device 910. The wake-up command may be used to distinguish between a voice signal that is irrelevant to the electronic device 910 and a voice signal related to the electronic device 910. The wake-up command may be configured as at least one designated or specified keyword such as “Hey Bixby”. The wake-up command may be a voice input required in order to identify whether the wake-up command corresponds to at least one keyword. The wake-up command may be voice input that does not need natural language processing or needs only a limited amount of natural language processing.

The voice signal may further include a voice command after the wake-up command. The voice command may be related to the purpose or reason of the voice signal uttered by the user. The voice command may include information indicating the service that the user desires to receive through the electronic device 910. The voice command may be configured as at least one text for interaction between the user and the electronic device 910, such as “Today's weather is” or “What is the title of the song being played now?”. The voice command may be voice input that requires identification of at least one text. The voice command may be voice input that requires natural language processing.

According to various embodiments, after reception of the voice signal is completed, the processor 1010 may provide an indication indicating reception of the voice signal through the output device 1050. For example, after reception of the voice signal is completed, the processor 1010 may provide a sound effect indicating reception of the voice signal, or may provide a visual object indicating reception of the voice signal through the output device 1050.

According to various embodiments, the processor 1010 may provide an indication indicating reception of the voice signal within duration of silence between the wake-up command within the voice signal and the voice command within the voice signal.

According to various embodiments, the processor 1010 may identify or recognize the wake-up command within the received voice signal. The processor 1010 may monitor whether the received voice signal includes at least one predetermined keyword. The processor 1010 may identify or recognize the wake-up command corresponding to at least one predetermined keyword within the received voice signal on the basis of the monitoring.

According to various embodiments, the processor 1010 may transmit information on the identified wake-up command to the server 905 linked to the electronic device 910 through the communication interface 1030. The processor 1010 may transmit information on the identified wake-up command to the server 905 linked to the electronic device 910 through the communication interface 1030 in response to identification of the wake-up command in order to determine or measure the reception quality of the voice signal received by the electronic device 910. The server 905 may determine a value indicating the reception quality of the voice signal on the basis of at least the information on the wake-up command transmitted from the electronic device 910. The value indicating the reception quality may include one or more of an audio gain of the wake-up command, a Received Signal Strength (RSS) of the wake-up command, a Signal-to-Noise Ratio (SNR) of the wake-up command, an energy distribution of the wake-up command, or a matching degree between the wake-up command and the at least one predetermined keyword.

According to various embodiments, the processor 1010 may determine the value indicating the reception quality of the voice signal on the basis of at least the identified wake-up command. For example, the processor 1010 may determine, as the value indicating the reception quality of the voice signal, one or more of an RSS of the identified wake-up command, a SNR of the identified wake-up command, an energy distribution of the wake-up command, and a matching degree between the wake-up command and at least one predetermined keyword. According to various embodiments, the processor 1010 may transmit information on the determined value to the server 905 through the communication interface 1030. The information on the determined value may be referred to as metadata.

The value indicating the reception quality of the voice signal determined by the electronic device 910 or the server 902 may be used to determine the device to transmit information on the voice command included within the voice signal to the server 905. For example, the server 905 may receive at least one value indicating the reception quality of the voice signal received by at least one electronic device from the at least one electronic device (for example, the electronic device 910-K) different from the electronic device 910 within the environment 900. The server 905 may determine the device receiving a voice signal with the highest reception quality by comparing the value indicating the reception quality of the voice signal received by the electronic device 910 and the value indicating the reception quality of the voice signal received by the at least one electronic device. The server 905 may determine the determined device as the device to transmit information on the voice command.

According to various embodiments, the processor 1010 may transmit information for identifying the electronic device 910 to the server 905 linked to the electronic device 910 through the communication interface 1030. The information for identifying the electronic device 910 may be used to indicate the device from which the information on the wake-up command or the information on the value indicating the reception quality of the voice signal received by the electronic device 910 is transmitted. The information for identifying the electronic device 910 may be used to identify a system (or environment) including the electronic device 910 transmitting the information on the wake-up command or the information on the value indicating the reception quality of the voice signal received by the electronic device 910. For example, the server 905 may identify that the device transmitting the information on the wake-up command or the information on the value indicating the reception quality of the voice signal received by the electronic device 910 is the electronic device 910 on the basis of at least the information for identifying the electronic device 910, received by the server 905. In another example, the server 905 may identify that the electronic device 910 is included within the system (or environment) including at least one other electronic device (for example, the electronic device 910-K) on the basis of at least the information for identifying the electronic device 910, received by the server 905. According to various embodiments, the information for identifying the electronic device 910 may include one or more of information on a manufacturer of the electronic device 910, production information of the electronic device 910, a device identifier (ID) of the electronic device 910, a user account of the electronic device 910, a pin code related to the electronic device 910, and a Medium Access Control (MAC) address of the electronic device 910. According to various embodiments, the information for identifying the electronic device 910 may be transmitted along with the information on the wake-up command or the information on the value indicating the reception quality of the voice signal received from the electronic device 910. According to various embodiments, transmission of the information for identifying the electronic device 910 may be independent from transmission of the information on the wake-up command or the information on the value indicating the reception quality of the voice signal received from the electronic device 910.

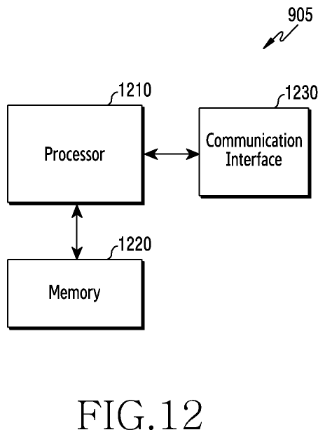

A detailed description of the operation of the server 905 related to the information for identifying the electronic device 910 will be made below with reference to FIG. 12.

According to various embodiments, the processor 1010 may receive a message from the server 905 through the communication interface 1030. For example, the processor 1010 may receive a message indicating transmission of information on the voice command to the server 905 from the server 905 through the interface 1030. When the electronic device 910 is determined as the device to transmit information on the voice command by the server 905, the processor 1010 may receive a message making a request for information on the voice command from the server 905 through the interface 1030. The message indicating transmission of the information on the voice command to the server 905 may be a response to the information on the wake-up command or a response to the information on the determined value. In another example, the processor 1010 may receive a message indicating deactivation of the microphone 1020 during a predetermined time interval from the server 905 through the communication interface 1030 or a message making a request for preventing transmission of the information on the voice command to the server 905. When the electronic device 910 is not determined as the device to transmit information on the voice command by the server 905, the processor 1010 may receive a message indicating deactivation of the microphone 1020 during a predetermined time interval from the server 905 through the interface 1030, or may receive a message making a request for preventing transmission of the information on the voice command to the server 905.

According to various embodiments, the processor 1010 may provide an indication through the output device 1050 in response to reception of the message making a request for information on the voice command from the server 905 through the interface 1030. The indication may be configured as various formats according to the characteristics, attributes, or capability of the output device 1050. For example, when the output device 1050 is a speaker capable of providing an audio signal, the indication may be configured as a notification sound. In another example, when the output device 1050 is a display capable of providing a visual object, the indication may be configured as a notification message. In another example, when the output device 1050 is an indicator configured as at least one element emitting light, the indication may be configured as light having a specific color.

According to various embodiments, the processor 1010 may transmit information on the voice command in response to reception of the message making a request for information on the voice command from the server 905 through the communication interface 1030. In other words, the processor 1010 may transmit the information on the voice command to the server 905 through the communication interface 1030 in response to the message received from the server 905.

According to various embodiments, the processor 1010 may receive feedback on the voice command from the server 905 through the communication interface 1030. The feedback may be a response to the voice command. The feedback may trigger a post operation of the electronic device 910. For example, the processor 1010 may provide information through the output device 1050 or switch the function of the electronic device 910 from an inactive state to an active state (for example, activate a display of a TV or activate an air purification function of an air conditioner). The feedback may be configured in various formats according to the characteristics of the response. For example, the feedback may be a control signal instructing or guiding the electronic device 910 to perform a specific function.

As described above, the processor 1010 within the electronic device 910 according to various embodiments may receive the voice signal and identify the wake-up command within the received voice signal. The processor 1010 may transmit information on the identified wake-up command to allow the server 905 to more efficiently recognize the voice command included in the voice signal or transmit information on the value indicating the reception quality of the voice signal determined on the basis of at least the identified wake-up command. The server 905 may receive the information not only from the electronic device 910 but also from at least one of the plurality of electronic devices included within the environment 900 so as to specify or determine the electronic device having the highest reception quality. The server 905 may acquire a voice command by making a request or providing a command for transmitting the information on the voice command to the specified electronic device. Since the acquired voice command has the highest reception quality, the server 905 may more efficiently recognize the voice command and transmit a response to the voice command. The server 905 according to various embodiments may make a request for preventing transmission of the voice command to another electronic device distinguished from the electronic device transmitting the information on the voice command, or may make a request for stopping reception of the voice signal through the microphone during a predetermined time interval. Through such a request, the environment 900 including the server 905 and the plurality of electronic devices (for example, the electronic devices 910-1 to 910-N) may prevent unnecessary resource consumption.

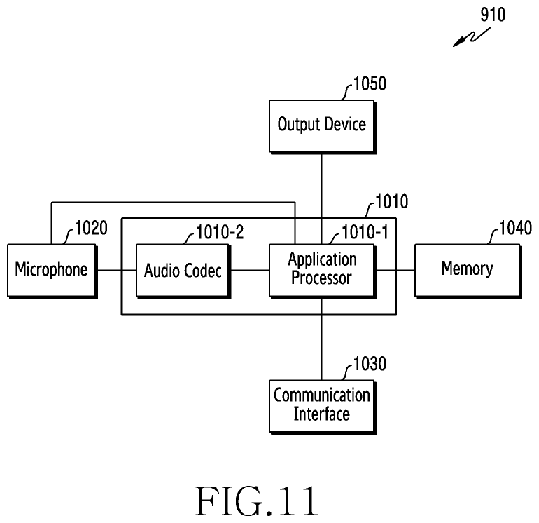

FIG. 11 illustrates another example of the functional configuration of the electronic device performing the operation related to voice recognition according to various embodiments. The functional configuration may be included in at least one of the plurality of electronic devices (electronic devices 910-1 to 910-N) illustrated in FIG. 9.

Referring to FIG. 11, the electronic device 910 may include a processor 1010, a microphone 1020, a communication interface 1030, a memory 1040, and an output device 1050.

The processor 1010 and the output device 1050 may correspond to the processor 1010 and the output device 1050 illustrated in FIG. 10, respectively.

The processor 1010 may include an application processor 1010-1 and an audio codec 1010-2.

The application processor 1010-1 may operate in an active state (or activate state). When power higher than or equal to reference power is supplied from a Power Management Integrated Circuitry (PMIC), the application processor 1010-1 may operate in the active state (or activate state). The active state may indicate a state in which an interrupt or task can be processed. The active state may be referred to as a wake-up state (or mode).

The application processor 1010-1 may operate in an inactive state according to the state of the electronic device 910. For example, when power lower than the reference power is provided from the PMIC according to the state of the electronic device 910, the application processor may operate in an idle state, a sleep state, or a standby state, in which booting is not needed for switching to the active state). In another example, when power supplied from the PMIC is blocked according to the state of the electronic device 910, the application processor 1010-1 may be in a powered-down (turn-off) state in which booting is needed for switching to the active state.

The audio codec 1010-2 may operate using less power than power for the application processor 1010-1 according to a clock frequency. For example, the audio codec 1010-2 may operate using less power than the power required by the application processor 1010-1 on the basis of a first clock frequency. The audio codec 1010-2, operating at the first clock frequency, may perform a function related to voice recognition through a link with the microphone 1020. In another example, the audio codec 1010-2 may operate using power corresponding to the power for the application processor 1010-1 on the basis of a second clock frequency, which is higher than the first clock frequency. The audio codec 1010-2 operating at the second clock frequency may perform pre-processing or post-processing of an audio signal. For example, the audio codec 1010-2 operating at the second clock frequency may perform Digital-to-Analog Converting (DAC) or Analog-to-Digital Converting (ADC) on the audio signal to reproduce the audio signal.

According to various embodiments, when the electronic device 910 is in the standby state, the application processor 1010-1 may be in the inactive state (deactivate state). For example, when the electronic device 910 is a TV, the electronic device 910 may operate in the state in which the display of the electronic device 910 is turned off. In this case, the application processor 1010-1 may be in the inactive state. The inactive state may be an idle state, a sleep state, or a standby state in which booting is not needed for switching to the active state. The inactive state may be a powered-down state in which booting is needed for switching to the active state.

The audio codec 1010-2 may operate on the basis of the first clock frequency while the application processor 1010-1 is in the inactive state. The audio codec 1010-2 operating at the first clock frequency may monitor whether a voice signal is received through the microphone 1020. The audio codec 1010-2 operating at the first clock frequency may consume less power than the power consumed by the application processor 1010-1 in the active state. The audio codec 1010-2 operating at the first clock frequency may identify whether the wake-up command is included in the voice signal in response to identification of reception of the voice signal through the microphone 1020. When the wake-up command is included in the voice signal, the audio codec 1010-2 operating at the first clock frequency may identify the wake-up command within the voice signal.

The audio codec 1010-2 operating at the first clock frequency may buffer the voice signal (or a voice command within the voice signal) in response to identification of the wake-up command. The audio codec 1010-2 operating at the first clock frequency may temporarily store the voice signal in response to identification of the wake-up command until the application processor 1010-1 switches to the active state.

The audio codec 1010-2 operating at the first clock frequency may transmit a signal for switching the application processor 1010 in the inactive state to the active to the PMIC or the application processor 1010-1 in response to identification of the wake-up command.

The application processor 1010-1 may switch to the active state on the basis of the signal transmitted from the audio codec 1010-2. For example, when the signal is transmitted to the PMIC, the PMIC may provide steady-state power to the application processor 1010-1. The application processor 1010-1 may switch to the active state on the basis of provision of the steady-state power. In another example, when the signal is transmitted to the application processor 1010-1, the application processor 1010-1 may make a request for providing steady-state power to the PMIC in response to reception of the signal. The application processor 1010-1 may switch to the active state in response to acquisition of the steady-state power from the PMIC.

The audio codec 1010-2 operating at the first clock frequency may provide information on the buffered voice signal to the application processor 1010-1 in response to identification of switching of the application processor 1010-1 to the active state.

Further, the application processor 1010-1 switching to the active state may receive a voice signal after the buffered voice signal through the microphone 1020. When the electronic device 910 is determined as the device to transmit information on the voice command by the server 905, the application processor 1010-1 may identify the voice command on the basis of at least the voice signal received through the microphone 1020 and the buffered voice signal.

The audio codec 1010-2 operating at the first clock frequency may provide information on the identified wake-up command to the application processor 1010-1 in response to identification that the application processor 1010-1 switches to the active state. The application processor 1010-1 may determine the value indicating the reception quality of the voice signal received by the electronic device 910 on the basis of at least the information on the wake-up command. The application processor 1010-1 may transmit information on the determined value to the server 905.

Meanwhile, the audio codec 1010-2 operating at the first clock frequency may operate at the second clock frequency, higher than the first clock frequency, in response to detection of the generation of an event for processing the audio signal different from the voice signal within the electronic device 910. For example, when the audio codec 1010-2 or the application processor 1010-1 detects reproduction of the audio signal within the electronic device 910 or detects activation of the display of the electronic device 910, the audio codec 1010-2 may operate at the second clock frequency. The power consumed by the audio codec 1010-2 operating at the second clock frequency may correspond to the power consumed by the application processor 1010-1 operating in the active state.

As described above, the electronic device 910 according to various embodiments may recognize the voice signal through the audio codec 1010-2 functionally connected to the microphone 1020 during the standby state, thereby reducing the amount of power consumed by recognition of the voice signal.

FIG. 12 illustrates an example of the functional configuration of a server according to various embodiments. The functional configuration may be included in the server 905 illustrated in FIG. 9.

Referring to FIG. 12, the server 905 may include a processor 1210, a memory 1220, and a communication interface 1230.

The processor 1210 may control the overall operation of the server 905. The processor 1210 may be operatively connected to other elements within the server 905, such as the communication interface 1230 and the memory 1220, in order to control the overall operation of the server 905.

The processor 1210 may receive commands of other elements of the server 905, analyze the received commands, and perform calculations or process data according to the analyzed commands.

The processor 1210 may process data or signals generated within the server 905. For example, the processor 1210 may make a request for a command, data, or a signal to the memory 1220. The processor 1210 may record (or store) or update commands, data, or signals within the memory 1220 to control the server 905 or control other elements within the server 905.

The processor 1210 may analyze and process messages, data, commands, or signals received from the communication interface 1230 and the memory 1220. The processor 1210 may generate a new message, data, command, or signal on the basis of the received message, data, command, or signal. The processor 1210 may provide the processed or generated messages, data, commands, or signals to the communication interface 1230 and the memory 1220.

The memory 1220 may store a command, a control command code, control information, or user data for controlling the server 905. For example, the memory 1220 may include an application, an Operating System (OS), middleware, and a device driver.

The communication interface 1230 may be used to generate or establish a communication path between another electronic device and the server 905 (for example, a communication path between the electronic device 910-K and the server 905). For example, the communication circuit 1230 may be a module for at least one of a Wireless Fidelity (Wi-Fi) communication scheme, a cellular (or mobile) communication scheme, or a wired communication scheme. The communication interface 1230 may provide a signal, information, data, or a message received from another electronic device to the processor 1210. The communication interface 1230 may transmit a signal, information, data, or a message provided from the processor 1210 to another electronic device.

According to various embodiments, the processor 1210 may receive information on the wake-up command or information on the value indicating the reception quality of the voice signal received from the electronic device 910 from the electronic device 910 through the communication interface 1230. The processor 1210 may receive information for identifying the electronic device 910 from the electronic device 910 through the communication interface 1230. According to various embodiments, the information for identifying the electronic device 910 may be received along with the information on the wake-up command or the information on the value indicating the reception quality of the voice signal received from the electronic device 910.

According to various embodiments, the information for identifying the electronic device 910 may be received before a predetermined time interval or after a predetermined time interval from the time point at which information on the wake-up command or information on the value indicating the reception quality of the voice signal received from the electronic device 910 is received.

According to various embodiments, the processor 1210 may inquire about or search a Database (DB) stored in the memory 1220 on the basis of the information for identifying the electronic device 910. The processor 1210 may inquire about or search for at least one electronic device related to the electronic device 910 within the database on the basis of the information for identifying the electronic device 910. According to various embodiments, at least one electronic device related to the electronic device 910 may be at least one device included in the same environment as the electronic device 910 (for example, the environment 900).

For example, at least one electronic device related to the electronic device 910 may be at least one device located near the electronic device 910 (or located within a predetermined distance from the electronic device 910). According to various embodiments, at least one electronic device related to the electronic device 910 may be at least one device registered in the database with the same user account as the electronic device 910. For example, the database may include a user account linked to the information for identifying the electronic device 910 and the information for identifying at least one electronic device.

According to various embodiments, the processor 1210 may monitor whether the information on the wake-up command or the information on the value indicating the reception quality of the voice signal received by at least one electronic device is received from at least one found electronic device during a predetermined time interval. According to various embodiments, the predetermined time interval may be configured differently depending on the area of the environment 900 including the electronic device 910 and at least one electronic device, the communication performance of the electronic device 910, and the communication performance of at least one electronic device.

According to various embodiments, the processor 1210 may receive the information on the wake-up command and the information on the value indicating the reception quality of the voice signal received by at least one electronic device from at least one electronic device through the communication interface 1230.

When the information on the wake-up command is received from the electronic device 910 and at least one electronic device, the processor 1210 may determine the value indicating the reception quality of the voice signal received by each of the plurality of electronic devices including the electronic device 910 and at least one electronic device on the basis of at least the received information. For example, the processor 1210 may determine the value indicating the reception quality of the voice signal received by the electronic device 910 on the basis of at least information on the wake-up command received from the electronic device 910 and determine at least one value indicating the reception quality of the voice signal received by at least one electronic device on the basis of at least the information on the wake-up command received from at least one electronic device. The processor 1210 may determine the device to transmit information on the voice command included in the voice signal on the basis of at least the value indicating the reception quality of the voice signal received by the electronic device 910 and the at least one value indicating the reception quality of the voice signal received by at least one electronic device. For example, the processor 1210 may determine, as the device to transmit the information on the voice command, the device receiving the voice signal with the highest reception quality among the plurality of electronic devices on the basis of at least the values.

When the plurality of values indicating the quality of reception of each of the voice signals received by the plurality of electronic devices are received from the plurality of electronic devices including the electronic device 910 and at least one electronic device, the processor 1210 may determine the device to transmit information on the voice command included in the voice signal on the basis of at least one of the plurality of values. For example, the processor 1210 may determine the device transmitting the highest value among the plurality of values as the device to transmit the information on the voice command.

According to various embodiments, the processor 1210 may transmit a message indicating (or making a request for) transmission of the information on the voice command to the device to transmit the information on the voice command through the communication interface 1230. In other words, the processor 1210 may make a request for transmitting the information on the voice command included in the voice signal to the device receiving the voice signal with the highest reception quality.

According to various embodiments, the processor 1210 may transmit a message making a request for preventing transmission of the information on the voice command to the server 905 to the remaining devices other than the device to transmit the information on the voice command among the plurality of electronic devices through the communication interface 1230 or a message making a request for deactivating microphones of the remaining devices during a predetermined time interval.

According to various embodiments, the processor 1210 may transmit another message making a request for transmitting information on an audio signal received by another electronic device outside the time interval in which the voice signal is received to another electronic device, distinguished from the device to transmit the information on the voice command, among the plurality of electronic devices through the communication interface 1230. For example, the processor 1210 may determine, as a device for noise canceling, another electronic device distinguished from the device to transmit the information on the voice command among the plurality of electronic devices. The processor 1210 may transmit a message indicating transmission of the information on the audio signal received by another electronic device outside the time interval in which the voice signal is received in order to cancel the noise included in the voice signal. The processor 1210 may compensate the voice command on the basis of at least the information on the audio signal. In other words, the processor 1210 may acquire a compensated voice command on the basis of at least the information on the audio signal.

According to various embodiments, the processor 1210 may receive the information on the voice command. The processor 1210 may recognize the voice command on the basis of at least the information on the received voice command. The processor 1210 may generate feedback on the voice command on the basis of the recognition.

According to various embodiments, the processor 1210 may identify that a user related to the voice signal is located near a specific electronic device among the plurality of electronic devices on the basis of at least the plurality of values indicating the reception quality of the voice signal. For example, the processor 1210 may determine that the user is located near the electronic device receiving the voice signal with the highest reception quality on the basis of at least the plurality of values. The processor 1210 may acquire information on the capability of the electronic device located near the user from the database in response to the determination. According to various embodiments, the database may include information on the capability of the electronic device linked to the information for identifying the electronic device. For example, the information on the capability of the electronic device may include information on the type of output device of the electronic device, attributes of the output device, or the characteristics of the output device.

According to various embodiments, the processor 1210 may determine the format of the feedback on the basis of at least the acquired information. For example, when the output device of the electronic device is determined to be a display on the basis of at least the acquired information, the processor 1210 may determine the format of the feedback as a screen display. In another example, when the output device of the electronic device is determined to be a speaker on the basis of at least the acquired information, the processor 1210 may determine the format of the feedback as voice output. In another example, when the output device of the electronic device is determined to be a light-emitting element on the basis of at least the acquired information, the processor 1210 may determine the format of the feedback as emission of light having a specific color. In another example, when the output device of the electronic device is determined to be a haptic module on the basis of at least the acquired information, the processor 1210 may determine the format of the feedback as haptic provision having a specific pattern. According to various embodiments, the processor 1210 may generate the feedback having the determined format.

According to various embodiments, the processor 1210 may transmit information on the feedback. The processor 1210 may transmit information on the feedback not only to the electronic device transmitting the information on the voice command but also to another electronic device. For example, when the output device of the electronic device transmitting the information on the voice command is a speaker and the output device of another electronic device arranged near the electronic device is a display, the processor 1210 may transmit the information on the feedback having a format for voice output to the electronic device and transmit the information on the feedback having a format for display output to another electronic device.

According to various embodiments, the processor 1210 may acquire information on a user's profile related to the electronic device (or a user account of the electronic device) from the database. For example, the database may include the user's profile linked to the user account. The user's profile may include data on a format of the feedback preferred by the user. The processor 1210 may determine the format of the feedback on the basis of at least the user's profile. For example, when the user is indicated in the database as preferring to receive the feedback through screen display, the processor 1210 may generate the feedback having the format for screen output. In another example, when the user is indicated in the database as preferring to receive the feedback through voice output, the processor 1210 may generate the feedback having the format for voice output. The processor 1210 may transmit information on the feedback having the determined format to a device capable of outputting the feedback according to the determined format.

According to various embodiments, the processor 1210 may generate a response to the voice command on the basis of recognition of the voice command. For example, when the voice command is relevant to operation of a specific device, the processor 1210 may generate the response to the voice command. The response may be distinguished from the feedback. While the feedback may indicate successful reception of the voice command or provision of information according to the voice command, the response may indicate operation of the specific device (or a function of the specific device) according to the voice command. In other words, the response may be relevant to activation or operation of a specific function, which is an operation distinguished from provision of information. The processor 1210 may determine at least one electronic device to transmit a response to the voice command on the basis of the recognition. For example, the processor 1210 may determine at least one electronic device to transmit the response to the voice command among a plurality of electronic devices included within the environment 900 on the basis of the recognition. The processor 1210 may transmit a control signal related to the response to at least one electronic device through the communication interface 1230 in order to operate at least one electronic device on the basis of the response.

As described above, the server 905 according to various embodiments may receive information on the voice command from the electronic device that receives the voice signal with the highest reception quality among the plurality of electronic devices receiving the voice signal. The server 905 according to various embodiments may improve the recognition rate of the voice command by recognizing the voice command on the basis of at least the received information on the voice command. Further, the server 905 according to various embodiments may more efficiently provide information or a server by determining a format of the feedback for the voice command on the basis of capability of a plurality of electronic devices within the system and a user's profile related to the voice command.

A system (for example, the server 905) according to various embodiments as described above may include a network interface (for example, the communication interface 1230), at least one processor (for example, the processor 1210) operatively connected to the network interface, and at least one memory (for example, the memory 1220) operatively connected to the at least one processor, wherein the memory stores instructions causing the at least one processor to, when executed, receive first data including first voice data related to a first user utterance and first metadata related to the first voice data through the network interface from a first external device, receive second data including second voice data related to the first user utterance and second metadata related to the second voice data from a second external device through the network interface, select one device from among the first external device and the second external device on the basis of at least the first metadata and the second metadata, provide a response related to the one selected device to the one selected device, and receive third data related to a second user utterance from the one selected device.

According to various embodiments, each of the first metadata and the second metadata may include at least one of an audio gain, a wake-up command confidence level, or a Signal-to-Noise Ratio (SNR).

An electronic device (for example, the electronic device 910) according to various embodiments as described above may include a microphone (for example, the microphone 1020), a speaker (for example, the output device 1050), a wireless communication circuit (for example, the communication interface 1030) configured to support Wireless Fidelity (Wi-Fi), a processor (for example, the processor 1010) operatively connected to the microphone, the speaker, and the wireless communication circuit, and a memory (for example, the memory 1040) operatively connected to the processor, wherein the memory may store instructions causing the processor to, when executed, receive a first user utterance through the microphone, transmit first data including first voice data related to the first user utterance and first metadata related to the first voice data to an external server through the wireless communication circuit, and receive a response related to an electronic device selected as an input device for a voice-based service from the external server through the wireless communication circuit.

According to various embodiments, the first metadata may include at least one of an audio gain, a wake-up command confidence level, or a Signal-to-Noise Ratio (SNR).

An electronic device according to various embodiments as described above may include a microphone (for example, the microphone 1020), a communication interface (for example, the communication interface 1030), and at least one processor (for example, the processor 1010), wherein the at least one processor may be configured to receive a voice signal through the microphone, identify a wake-up command within the voice signal, determine a value indicating a reception quality of the voice signal based at least on the wake-up command, and transmit information on the determined value to a server through the communication interface.

According to the various embodiments, the voice signal may further include a voice command subsequent to the wake-up command, and the at least one processor may be configured to transmit the information on the determined value to the server through the communication interface in order to allow the server to determine the device which is to transmit information on the voice command to the server among a plurality of electronic devices including the electronic device and at least one other electronic device receiving the voice signal. According to various embodiments, the electronic device may further include an output device (for example, the output device 1050) , and the at least one processor may be configured to receive a message indicating transmission of the voice command to the server from the server through the communication interface, transmit the information on the voice command to the server through the communication interface in response to the reception, and provide an indication through the output device in response to the reception. According to various embodiments, the message may be transmitted from the server to the electronic device on the basis of at least the information on the determined value and information on at least one other value, which is transmitted from the at least one other electronic device to the server and indicate the reception quality of the wake-up command in the at least one other electronic device.

According to various embodiments, the electronic device may further include an output device (for example, the output device 1050), and the at least one processor may be further configured to provide, through the output device, an indication indicating reception of the voice signal after the reception of the voice signal is completed.

According to various embodiments, the electronic device may further include an output device (for example, the output device 1050), and the at least one processor may be further configured to provide, through the output device, an indication indicating reception of the voice signal within the duration of silence between the wake-up command and the voice command.

According to various embodiments, the at least one processor may include an application processor (for example, the application processor 1010-1) and an audio codec chip (for example, the audio codec 1010-2), and the audio codec chip may be configured to receive the voice signal through the microphone, based on a first clock frequency, identify the wake-up command within the voice signal in response to the reception, transmit a signal for switching the state of the application processor to a wake-up state to the application processor in response to the identification, and transmit information on the identified wake-up command to the processor switching to the wake-up state, and the processor switching to the wake-up state may be configured to determine the value indicating the reception quality of the voice signal on the basis of at least the information on the identified wake-up command and transmit information on the determined value to the server through the communication interface. According to various embodiments, the audio codec chip may be further configured to buffer the voice signal until the processor switches to the wake-up state and provide information on the buffered voice signal to the processor in response to identification that the processor switches to the wake-up state.

A server according to various embodiments as described above may include a communication interface (for example, the communication interface 1230) and a processor (for example, the processor 1210), wherein the processor may be configured to receive information on a first value indicating the reception quality of a voice signal received by a first electronic device from the first electronic device through the communication interface, receive information on a second value indicating the reception quality of the voice signal received by a second electronic device from the second electronic device through the communication interface, determine an electronic device to transmit a voice command included in the voice signal among a plurality of electronic devices including the first electronic device and the second electronic device on the basis of at least the first value and the second value, and transmit a message indicating transmission of information on the voice command to the determined electronic device through the communication interface.

According to various embodiments, the processor may be configured to receive, from the second electronic device, the information on the second value indicating the reception quality of the voice signal received by the second electronic device within a predetermined time interval from the time point at which the information on the first value is received through the communication interface.

According to various embodiments, each of the first value and the second value may be included in the voice signal, and may be determined based at least on a wake-up command prior to the voice command.

According to various embodiments, the processor may be configured to determine the first electronic device as the electronic device to transmit the voice command based on identification that the first value is higher than the second value, transmit the message indicating transmission of the information on the voice command to the first electronic device through the communication interface, determine the second electronic device as the electronic device to transmit the voice command is lower than the second value, and transmit the message indicating transmission of the information on the voice command to the second electronic device through the communication interface.

According to various embodiments, the processor may be further configured to receive information on the voice command from the determined electronic device through the communication interface in response to the message, generate feedback for the voice command, and transmit information on the feedback through the communication interface. According to various embodiments, the processor may be configured to identify that a user related to the voice signal is located near a third electronic device among the plurality of electronic devices, based at least on the first value and the second value, acquire information on the capability of the third electronic device from a database stored in a memory of the server, determine the format of the feedback based at least on the information on the capability of the third electronic device, and transmit the information on the feedback having the determined format to the third electronic device through the communication interface. According to various embodiments, the format may include one or more of voice output, screen display, light emission, or haptic provision.

According to various embodiments, the processor may be further configured to determine at least one electronic device to make a response to the voice command among the plurality of electronic devices and transmit a control signal related to the response to the at least one electronic device through the communication interface in order to allow the at least one electronic device to operate based on the response.

According to various embodiments, the processor may be configured to determine another electronic device, distinct from the electronic device determined among the plurality of electronic devices on the basis of at least the first value and the second value, transmit another message indicating transmission of information on an audio signal received by another electronic device outside the time interval in which the voice signal is received to another electronic device through the communication interface, receive the information on the audio signal in response to another message from the determined another electronic device through the communication interface, compensate the voice command on the basis of at least the information on the audio signal, generate feedback for the compensated voice command, and transmit information on the feedback through the communication interface.

According to various embodiments, the processor may be configured to acquire information on a user profile related to the first electronic device and the second electronic device from the database, determine the format of the feedback on the basis of at least the information on the profile, and transmit the information on the feedback having the determined format through the communication interface.

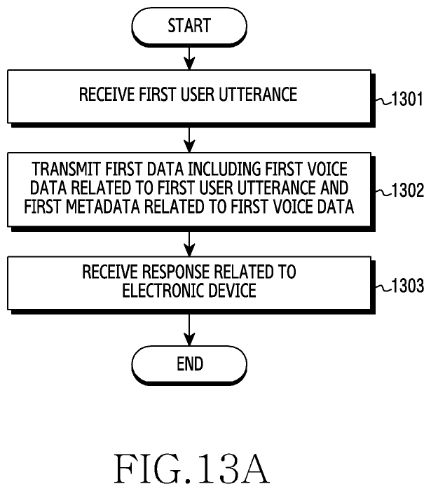

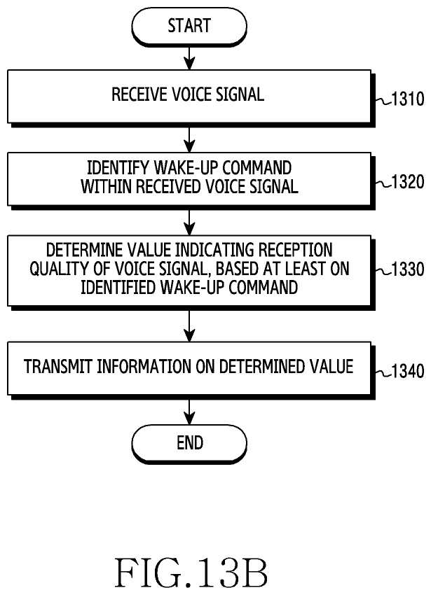

FIG. 13A illustrates an example of operation of an electronic device according to various embodiments. The operation may be performed by the electronic device 910 or the processor 1010 included in the electronic device 910 illustrated in FIG. 10.

Referring to FIG. 13A, in operation 1301, the processor 1010 may receive a first user utterance through the microphone 1020. The first user utterance may include the wake-up command. The processor 1010 may receive the first user utterance indicating recognition of a voice command through the microphone 1020.

In operation 1302, the processor 1010 may transmit first voice data related to the first user utterance and first data including first metadata related to the first voice data to the server 905 linked to the electronic device 910 through the communication interface 1030. The first voice data may include information related to the first user utterance. The first voice data may include information on the wake-up command. According to various embodiments, the first metadata may include information for identifying the electronic device 910. The first metadata may be used to indicate that the device transmitting the first data is the electronic device 910. The first metadata may be used to identify the system (or the environment 900) including the electronic device 910. For example, the first metadata may be used by the server 905 to inquire about a user account related to the electronic device 910. According to various embodiments, the first metadata may include at least one of an audio gain for the first voice data related to the first user utterance, a confidence level for the wake-up command included in the first user utterance, or a Signal-to-Noise Ratio (SNR) for the first voice data. The first metadata may be used to determine the reception quality of the first user utterance received by the electronic device 910. For example, the first metadata may be compared with second metadata included in second data transmitted from another electronic device to the server 905. The second metadata may be related to second voice data related to the first user utterance received by another electronic device transmitting the second data. The server 905 may determine which device receives the first user utterance with a higher reception quality by comparing the first metadata and the second metadata.

In operation 1303, the processor 1010 may receive a response related to the electronic device 910 selected as an input device for a voice-based service from the server 905 through the communication interface 1030. For example, the server 905 receiving the first data and the second data may determine the device to transmit information on the second user utterance on the basis of at least the first metadata and the second metadata. When the reception quality indicated by the first metadata is higher than the reception quality indicated by the second metadata, the server 905 may determine the electronic device 910 as the device to transmit information on the second user utterance. The second user utterance may include information on the voice command. The response may include information making a request for transmitting the second user utterance. The response may include information making a request for receiving the second user utterance through the microphone 1020.

The processor 1010 may provide an indication through the output device 1050 in response to reception of the response. The format of the indication may be configured variously depending on the format of the output device 1050. For example, when the output device 1050 is a display, the format of the indication may be related to screen display. In another example, when the output device 1050 is a speaker, the format of the indication may be related to output of an audio signal.

The processor 1010 may receive the second user utterance including the voice command through the microphone 1020 in response to reception of the response. The processor 1010 may transmit information on the second user utterance to the server 905 through the communication interface 1030.

As described above, the processor 1010 of the electronic device 910 according to various embodiments may transmit, to the server 905, the first voice data related to the first user utterance including the wake-up command and the first metadata related to the first voice data to the server 905 so as to provide information for determining the device that will receive a second user utterance to be received after the first user utterance. Through provision of the information, the processor 1010 may guide the server 905 to determine the device to receive the second user utterance having a higher recognition rate.

FIG. 13B illustrates another example of the operation of the electronic device according to various embodiments. The operation may be performed by the electronic device 910 or the processor 1010 included in the electronic device 910 illustrated in FIG. 10.

Referring to FIG. 13B, in operation 1301, the processor 1010 may receive a voice signal through the microphone 1020. The voice signal may be generated by the user of the electronic device 910. The voice signal may include the wake-up command.

In operation 1320, the processor 1010 may identify the wake-up command within the voice signal. The processor 1010 may inquire about reference information related to voice recognition stored in the memory 1040 in response to reception of the voice signal. The reference information may include data on at least one keyword related to the wake-up command. The processor 1010 may recognize the wake-up command corresponding to at least one keyword within the received voice signal.

In operation 1330, the processor 1010 may determine a value indicating the reception quality of the voice signal on the basis of at least the identified wake-up command. For example, the processor 1010 may determine the audio gain of the audio signal as the value indicating the reception quality of the voice signal on the basis of at least the identified wake-up command. In another example, the processor 1010 may determine the confidence level of the wake-up command as the value indicating the reception quality of the voice signal on the basis of at least the identified wake-up command. In another example, the processor 1010 may determine the reception intensity the voice signal as the value indicating the reception quality of the voice signal on the basis of at least the identified wake-up command. In another example, the processor 1010 may determine a signal-to-noise ratio of the voice signal as the value indicating the reception quality of the voice signal on the basis of at least the identified wake-up command.

In operation 1340, the processor 1010 may transmit information on the determined value to the server 905. The voice signal may further include a voice command after the wake-up command. The processor 1010 may transmit the information on the determined value through the communication interface 1030 in order to allow the server 905 to determine the device to transmit the information on the voice command to the server 905 among a plurality of electronic devices including the electronic device 910 and at least one other electronic device receiving the voice signal. According to various embodiments, the information on the determined value may be transmitted along with information for identifying the electronic device 910. The information for identifying the electronic device 910 may be used to indicate that the information on the determined value is transmitted from the electronic device 910. The information for identifying the electronic device 910 may be used by the server 905 to identify at least one other electronic device related to the voice signal. For example, the server 905 may identify at least one electronic device which shares the user account with the electronic device 910 (or is located near the electronic device 910) by searching a database stored in the memory 1220 on the basis of the information for identifying the electronic device 910. The server 905 may monitor whether information on at least one other value indicating the reception quality of the voice signal of at least one other electronic device is received from at least one other electronic device during a predetermined time interval on the basis of identification of at least one other electronic device. When the information on at least one other value indicating the reception quality of the voice signal of at least one other electronic device is received from at least one other electronic device, the server 905 may determine the device receiving the voice signal with the highest reception quality on the basis of at least information on the value received from the electronic device 910 and information on at least one other value received from at least one other electronic device.

As described above, the electronic device 910 according to various embodiments may transmit information on the value indicating the reception quality of the voice signal received by the electronic device 910 to the server 905 to allow the server 905 to determine the device receiving the voice signal with the highest quality. Through signaling with the server 905, the electronic device 910 may improve the recognition rate of the voice signal.

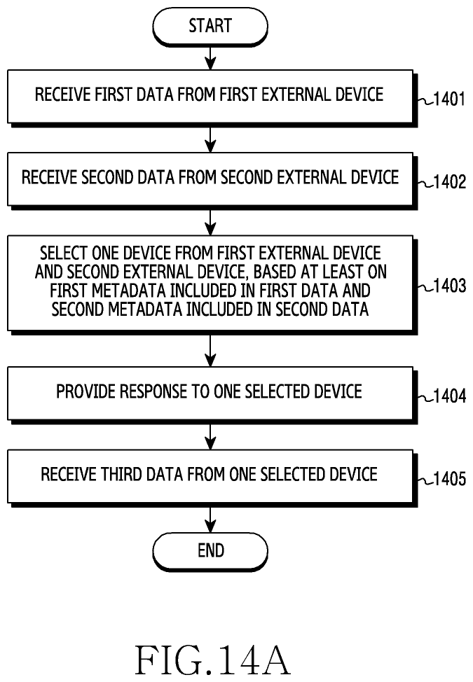

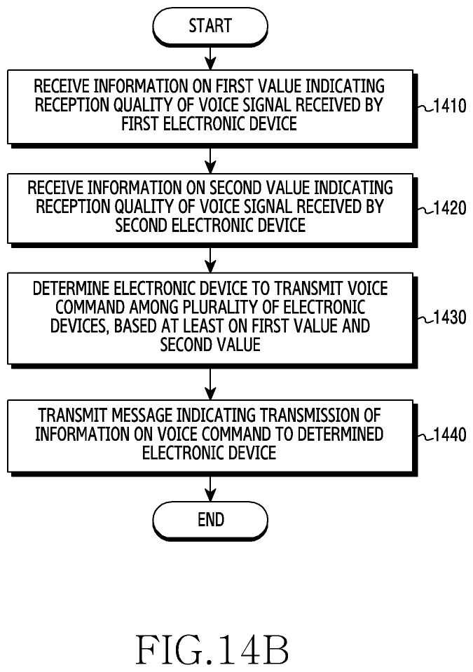

FIG. 14A illustrates an example of operation of a server according to various embodiments. The operation may be performed by the server 905 or the processor 1210 included in the server 905 illustrated in FIG. 12.

Referring to FIG. 14A, in operation 1401, the processor 1210 may receive first data from a first external device (for example, the electronic device 910-1). The first data may include first voice data related to a first user utterance. The first user utterance may be received by the first external device through a microphone of the first external device. The first data may include first metadata related to the first voice data.

The first metadata may include information for identifying the first external device. The information for identifying the first external device may be used to identify the entity that is to transmit the first data. The information for identifying the first external device may be used to identify whether there is another device related to the first external device. According to various embodiments, the processor 1210 may inquire about the database stored in the memory 1220 on the basis of at least the information for identifying the first external device. The processor 1210 may identify whether there is another device within a predetermined distance from the first external device through the inquiry. For example, the processor 1210 may identify a user account linked to the information for identifying the first external device within the database. The processor 1210 may identify that the user account is linked not only to the first external device but also to information for identifying at least one other device. The processor 1210 may monitor whether other data having a format corresponding to the first data is received from at least one other device on the basis of the identification.

The first metadata may include information related to the reception quality of the first user utterance received by the first external device. For example, the first metadata may include at least one of an audio gain of the first user utterance, a confidence level of the wake-up command within the first user utterance, or a signal-to-noise ratio of the first user utterance. The first metadata may be compared with other metadata received by the server 905 from at least some of the at least one device. Through the comparison, the processor 1210 may determine the device having the highest reception quality.

In operation 1402, the processor 1210 may receive second data from a second external device. The format of the second data may correspond to the format of the first data. For example, the second data may include second voice data related to the first user utterance. The second data may include the second voice data, which is data on the first user utterance received by the second external device. The second data may include second metadata related to the second voice data. The processor 1210 may monitor whether data is received from at least one device including the second external device for a predetermined time after the first data is received from the first external device. The processor 1210 may receive the second data from the second external device among at least one device.

The second metadata may include information for identifying the second external device. The second metadata may include information related to the reception quality of the first user utterance received by the second external device.

In operation 1403, the processor 1210 may select one device from among the first external device and the second external device on the basis of at least the first metadata and the second metadata. The processor 1210 may compare the reception quality of the first user utterance in the first external device indicated by the first metadata with the reception quality of the first user utterance in the second external device indicated by the second metadata. The processor 1210 may select one device from among the first external device and the second external device on the basis of the comparison result. For example, the processor 1210 may select, as one device, the second external device receiving the first user utterance with higher reception quality than the reception quality of the first user utterance in the first external device.

In operation 1404, the processor 1210 may provide a response to the one selected device. For example, the processor 1210 may provide the response to the one selected device through the communication interface 1230. The response may be a message making a request for transmitting third data related to the second user utterance, subsequent to the first user utterance, to the one selected device. The response may be a message making a request for receiving the second user utterance. The response may cause an indication within the one selected device. For example, the one selected device receiving the response may provide an indication.

In operation 1405, the processor 1210 may receive third data from the one selected device. The third data may be related to the second user utterance. The third data may include third voice data related to the second user utterance. The third voice data may include a voice command. The processor 1210 may generate feedback for the voice command and transmit the generated feedback to the one selected device or to a device different from the one selected device.

As described above, the processor 1210 within the server 905 according to various embodiments may receive metadata from a plurality of devices receiving a user utterance so as to determine the device receiving the user utterance with the highest reception quality among the plurality of devices. Through the determination, the server 905 may improve the recognition rate of the voice command included in the user utterance.

FIG. 14B illustrates another example of the operation of a server according to various embodiments. The operation may be performed by the server 905 or the processor 1210 included in the server 905 illustrated in FIG. 12.

Referring to FIG. 14B, in operation 1410, the processor 1210 may receive information on a first value indicating the reception quality of a voice signal received by a first electronic device from the first electronic device through the communication interface 1230. The first value may be determined on the basis of a wake-up command within the voice signal received through a microphone of the first electronic device. The information on the first value may be received along with information for identifying the first electronic device. The processor 1210 may identify whether at least one electronic device related to the first electronic device is registered in the database stored in the memory 1220 on the basis of the information for identifying the first electronic device. When at least one electronic device is registered in the database, the processor 1210 may identify whether information on at least one value indicating the reception quality of the voice signal received by at least one electronic device is received from the at least one electronic device for a predetermined time.

In operation 1420, the processor 1210 may receive information on a second value, indicating the reception quality of the voice signal received by a second electronic device, from the second electronic device among at least one electronic device through the communication interface 1230 for a predetermined time. The second value may be determined on the basis of a wake-up command within the voice signal received through a microphone of the second electronic device. The information on the second value may be received along with information for identifying the second electronic device. The processor 1210 may determine that the second value is related to the first value on the basis of the information for identifying the second electronic device. The processor 1210 may identify that the information for identifying the first electronic device and the information for identifying the second electronic device are linked to the same user account on the basis of data stored in the database. The processor 1210 may determine that the second value is related to the first value on the basis of the identification.

In operation 1430, the processor 1210 may determine the electronic device to transmit a voice command included in the voice signal among a plurality of electronic devices including the first electronic device and the second electronic device on the basis of at least the first value and the second value. For example, the processor 1210 may determine the first electronic device as the electronic device to transmit information on the voice command on the basis of identification that the first value is higher than the second value. In another example, the processor 1210 may determine the second electronic device as the electronic device to transmit information on the voice command on the basis of identification that the first value is lower than the second value.

In operation 1440, the processor 1210 may transmit a message indicating transmission of the information on the voice command to the determined electronic device through the communication interface 1230. The processor 1210 may transmit a message making a request for transmitting the information on the voice command to the determined electronic device receiving the voice signal with a higher reception quality.

As described above, the server 905 according to various embodiments may receive information on a value indicating the reception quality of the voice signal received from each of a plurality of electronic devices receiving the voice signal. The server 905 may determine the electronic device to make a request for information on the voice command among the plurality of electronic devices on the basis of at least the value indicating the reception quality of the voice signal. The server 905 may acquire information on the voice command having a higher reception quality by making a request for information on the voice command to the determined electronic device. The server 905 may improve the recognition rate of the voice command through the acquisition.

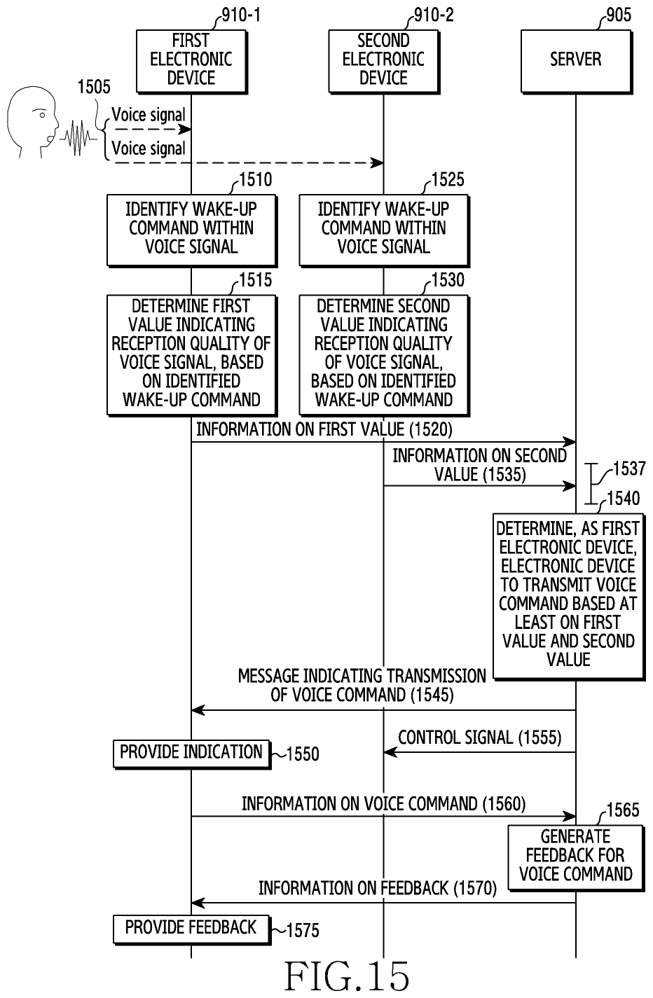

FIG. 15 illustrates an example of signaling between a plurality of electronic devices and a server according to various embodiments. The signaling may take place between the plurality of electronic devices (for example, the electronic devices 910-1 to 910-N) illustrated in FIG. 9 and the server 905 illustrated in FIG. 9.

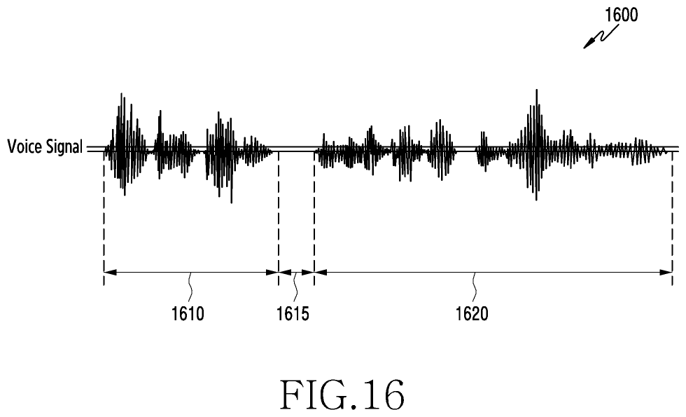

FIG. 16 illustrates an example of formats of voice signals received by a plurality of electronic devices according to various embodiments.

Referring to FIG. 15, in operation 1505, the first electronic device 910-1 and the second electronic device 910-2 may receive voice signals from the user. Since the area in which the first electronic device 910-1 is located may be different from the area in which the second electronic device 910-2 is located, the audio gain of the voice signal received by the first electronic device 910-1 may be different from the audio gain of the voice signal received by the second electronic device 910-2.

In operation 1510, the first electronic device 910-1 may identify a wake-up command within the voice signal. For example, referring to FIG. 16, a voice signal 1600 may include a wake-up command 1610. The wake-up command 1610 may be configured as at least one predetermined keyword. The voice signal 1600 may further include a voice command 1620. The voice signal 1600 may further include the duration of silence 1615 between the wake-up command 1610 and the voice command 1620. The first electronic device 910-1 may identify the duration of silence 1615 within the voice signal 1600 and recognize a received portion previous to the duration of silence 1615. The first electronic device 910-1 may compare the recognized part with at least one predetermined keyword. When it is identified that at least some of the recognized part corresponds to at least one predetermined keyword, the first electronic device 910-1 may identify the recognized part as the wake-up command 1610.

In operation 1515, the first electronic device 910-1 may determine a first value indicating the reception quality of the voice signal 1600 on the basis of the identified wake-up command 1610.

In operation 1520, the first electronic device 910-1 may transmit information on the first value to the server 905. The server 905 may receive the information on the first value.

Meanwhile, in operation 1525, the second electronic device 910-2 may identify a wake-up command within the voice signal. The second electronic device 910-2 may identify the wake-up command within the voice signal through a method similar to that performed by the first electronic device 910-1.

In operation 1530, the second electronic device 910-2 may determine a second value indicating the reception quality of the voice signal on the basis of the identified wake-up command. In operation 1535, the second electronic device 910-2 may transmit information on the second value to the server 905. The server 905 may receive the information on the second value from the second electronic device 910-2. The server 905 may receive the information on the second value from the second electronic device 910-2 within a predetermined time interval 1537. The predetermined time interval 1537 may be the time interval during which the server 905 waits to receive information on a value indicating a reception quality of the voice signal received by another electronic device along with the information on the second value from another electronic device receiving the voice signal. The predetermined time interval 1537 may be configured differently depending on the communication performance of each of the first electronic device 910-1 and the second electronic device 910-2 or on the area of the environment 900 including the first electronic device 910-1 and the second electronic device 910-2.

In operation 1540, the server 905 may determine the electronic device to transmit a voice command as the first electronic device 910-1 on the basis of at least the first value and the second value. For example, when the first value is higher than the second value, the server 905 may determine the electronic device to transmit the voice command as the first electronic device 910-1.

In operation 1545, the server 905 may transmit a message, indicating transmission of the voice command to the server 905, to the first electronic device 910-1 on the basis of the determination. The server 905 may make a request for transmitting the voice command to the first electronic device 910-1 in order to acquire a voice command having a higher quality. The first electronic device 910-1 may receive the request.

In operation 1550, the first electronic device 910-1 may provide an indication in response to reception of the message (or request). The indication may be used to indicate reception of the message (or request). The indication may have various formats according to the type of an output device of the first electronic device 910-1. For example, when the output device of the first electronic device 910-1 is a light-emitting device, the indication may be configured as emission of light of a specific color. In another example, when the output device of the first electronic device 910-1 is a speaker, the indication may be configured as output of a specific audio signal.

In operation 1555, the server 905 may transmit a control signal to the second electronic device 910-2. The server 905 may transmit the control signal to the second electronic device 910-2, which is not selected as the electronic device to transmit the voice command. According to various embodiments, the control signal may be used by the second electronic device 910-2 to make a request to stop receiving the voice signal. According to various embodiments, the control signal may be used by the second electronic device 910-2 to make a request for preventing transmission of the information on the voice command to the server 905. According to various embodiments, the control signal may be used to make a request for deactivating a microphone of the second electronic device 910-2 for a specific time interval. The server 905 may transmit the control signal to the second electronic device 910-2 in order to save power consumed by reception of the voice signal or transmission of the information on the voice command. The second electronic device 910-2 may receive the control signal. Operation 1555 may be omitted or bypassed depending on the embodiment.

In operation 1560, the first electronic device 910-1 may transmit information on the voice command 1620 included in the voice signal to the server 905 in response to reception of the message (or request). The first electronic device 910-1 may transmit information on the voice command 1620 to the server 905 in order to provide a user interaction. The server 905 may receive the information on the voice command 1620.

Although FIG. 15 illustrates an example in which operation 1560 is performed after operation 1550, operations 1550 and 1560 may be performed in any sequence. For example, operations 1550 and 1560 may be performed in the reverse of the order shown in FIG. 15 or simultaneously.

In operation 1565, the server 905 may generate feedback for the voice command 1620. According to various embodiments, the server 905 may recognize the voice command on the basis of natural language processing for the voice command performed by the server 905. According to various embodiments, the server 905 may recognize the voice command on the basis of natural language processing for the voice command performed by another server linked with the server 905. The server 905 may generate feedback on the basis of the recognized voice command. The generation of the feedback may be performed by the server 905, or may be performed by a link between the server 905 and another server.

In operation 1570, the server 905 may transmit information on the feedback to the first electronic device 910-1. The information on the feedback may indicate normal reception of the information on the voice command. The information on the feedback may include data to be acquired by the user through the voice command. The first electronic device 910-1 may receive the information on the feedback.

In operation 1575, the first electronic device 910-1 may provide the feedback. For example, the first electronic device 910-1 may provide the feedback through the output device 1050.

As described above, the server 905 according to various embodiments may acquire information on a voice command having a higher quality through signaling with a plurality of electronic devices (for example, the first electronic device 910-1 and the second electronic device 910-2) related to the reception quality of the voice signal. The server 905 according to various embodiments may provide information having improved accuracy to the user by generating feedback on the basis of the voice command having higher quality.

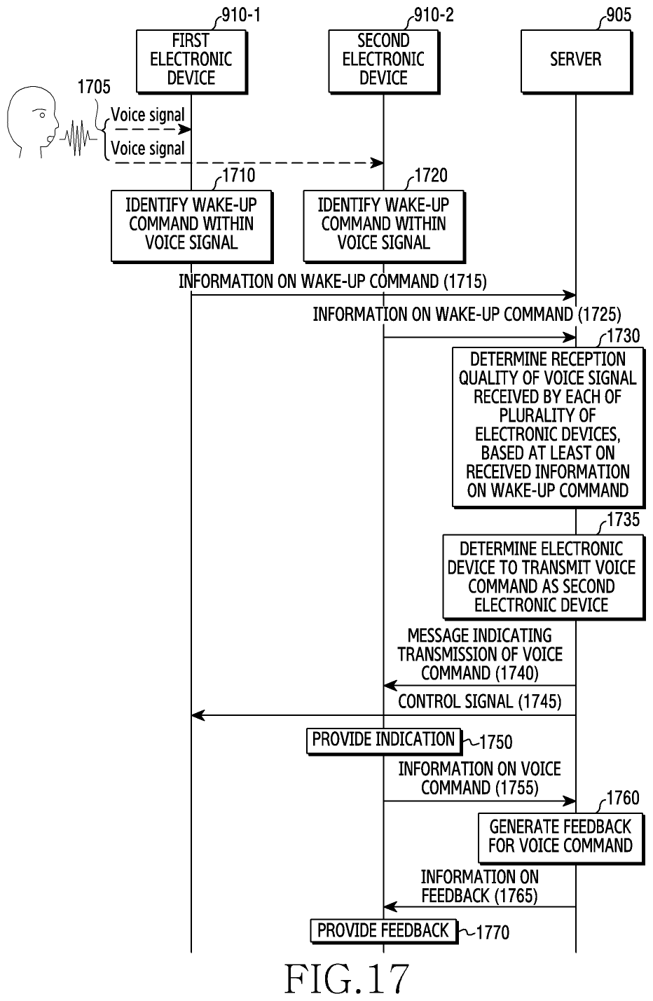

FIG. 17 illustrates another example of signaling between a plurality of electronic devices and a server according to various embodiments. The signaling may be generated between the plurality of electronic devices (for example, the electronic devices 910-1 to 910-N) illustrated in FIG. 9 and the server 905 illustrated in FIG. 9.

Referring to FIG. 17, in operation 1705, the first electronic device 910-1 and the second electronic device 910-2 may receive voice signals from the user.

In operation 1710, the first electronic device 910-1 may identify a wake-up command within the voice signal received by the first electronic device 910-1.

In operation 1715, the first electronic device 910-1 may transmit information on the wake-up command identified by the first electronic device 910-1 to the server 905. The server 905 may receive the information on the wake-up command identified by the first electronic device 910-1.

In operation 1720, the second electronic device 910-2 may identify a wake-up command within the voice signal received by the second electronic device 910-2.

In operation 1725, the second electronic device 910-2 may transmit information on the wake-up command identified by the second electronic device 910-2 to the server 905. The server 905 may receive the information on the wake-up command identified by the second electronic device 910-2.

In operation 1730, the server 905 may determine the reception quality of the voice signal received by each of the plurality of electronic devices including the first electronic device 910-1 and the second electronic device 910-2 on the basis of at least the received information. For example, the server 905 may determine the reception quality of the voice signal received by the first electronic device 910-1 on the basis of at least the information on the wake-up command identified by the first electronic device 910-1 and determine the reception quality of the voice signal received by the second electronic device 910-2 on the basis of at least the information on the wake-up command identified by the second electronic device 910-2.

In operation 1735, the server 905 may determine the electronic device to transmit the information on the voice command included in the voice signal as the second electronic device 910-2. For example, the server 905 may determine the electronic device to transmit the information on the voice command as the second electronic device 910-2 on the basis of identification that the reception quality of the voice signal received by the second electronic device 910-2 is better than the reception quality of the voice signal received by the first electronic device 910-1.

In operation 1740, the server 905 may transmit a message indicating transmission of the voice command to the second electronic device 910-2. The second electronic device 910-2 may receive the message.

In operation 1745, the server 905 may transmit a control signal indicating not to transmit information on the voice command to the first electronic device 910-1. The first electronic device 910-1 may receive the control signal.

In operation 1750, the second electronic device 910-2 may provide an indication on the basis of reception of the message. In operation 1755, the second electronic device 910-2 may transmit information on the voice command to the server 905 on the basis of reception of the message. The server 905 may receive the information on the voice command.

Operations 1750 and 1755 may be performed in any sequence.

In operation 1760, the server 905 may generate feedback for the voice command. The server 905 may generate the feedback on the basis of recognition of the voice command.

In operation 1765, the server 905 may transmit information on the feedback to the second electronic device 910-2. The second electronic device 910-2 may receive the information on the feedback.

In operation 1770, the second electronic device 910-2 may provide the feedback on the basis of the received information. The feedback may include information corresponding to the voice command.

As described above, the plurality of electronic devices (for example, the first electronic device 910-1 and the second electronic device 910-2) according to various embodiments may grant permission to determine the reception quality of the voice signal received by each of the plurality of electronic devices to the server 905. Through the granting of permission, each of the plurality of electronic devices may reduce the amount of power consumed to determine reception quality. Further, through the granting of permission, each of the plurality of electronic devices may reduce the number of calculations for determining the reception quality.

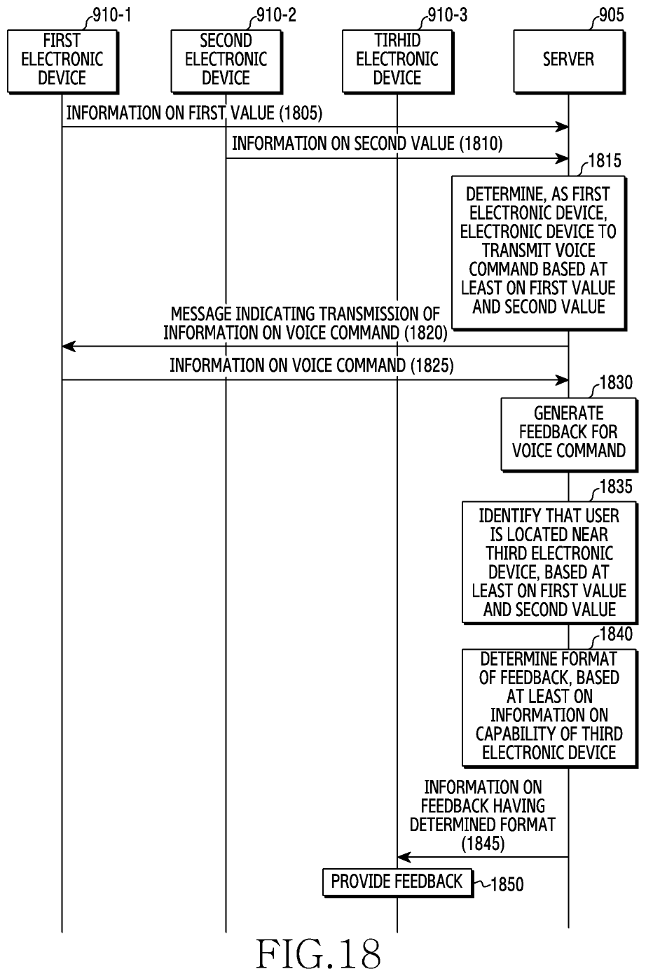

FIG. 18 illustrates another example of signaling between a plurality of electronic devices and a server according to various embodiments. The signaling may be generated between the plurality of electronic devices (for example, the electronic devices 910-1 to 910-N) illustrated in FIG. 9 and the server 905 illustrated in FIG. 9.

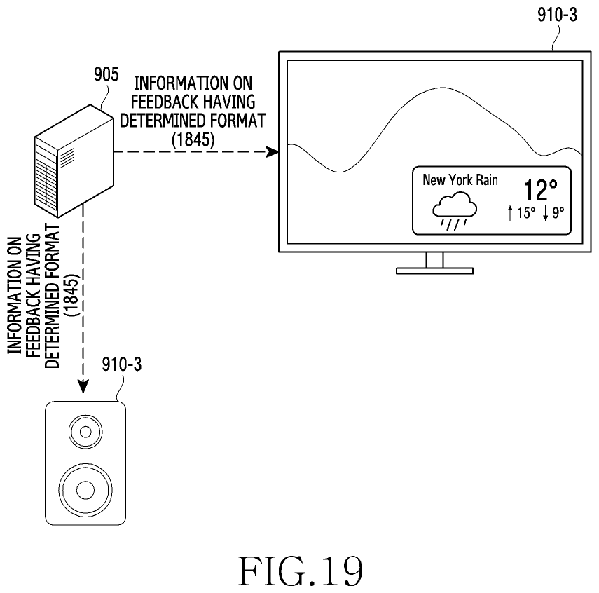

FIG. 19 illustrates an example of an operation of a server providing feedback according to various embodiments.

Referring to FIG. 18, in operation 1805, the first electronic device 910-1 receiving the voice signal may transmit information on the first value to the server 905. The server 905 may receive the information on the first value.

In operation 1810, the second electronic device 910-2 receiving the voice signal may transmit information on the second value to the server 905. The server 905 may receive the information on the second value. According to various embodiments, the server 905 may receive the information on the second value within the predetermined time interval.

In operation 1815, the server 905 may determine the electronic device to transmit a voice command as the first electronic device 910-1 on the basis of at least the first value and the second value. The server 905 may determine the first electronic device 910-1 transmitting the information on the first value, higher than the second value, as the electronic device to transmit the information on the voice command.

In operation 1820, the server 905 may transmit a message indicating transmission of information on the voice command included in the voice signal to the first electronic device 910-1 in response to the determination. The first electronic device 910-1 may receive the message.

In operation 1825, the first electronic device 910-1 may transmit information on the voice command in response to reception of the message. The server 905 may receive the information on the voice command.

In operation 1830, the server 905 may generate feedback for the voice command on the basis of reception of the voice command.

In operation 1835, the server 905 may identify that the user making the voice signal is located near a third electronic device on the basis of at least the first value and the second value. For example, the server 905 may determine a first distance between the user and the first electronic device 910-1 on the basis of the first value, and may determine a second distance between the user and the second electronic device 910-2 on the basis of the second value. The server 905 may determine the positional relationship between the first electronic device 910-1 and the user and the positional relationship between the second electronic device 910-2 and the user on the basis of at least the first distance and the second distance. Further, the server 905 cannot receive the voice signal since there is no microphone on the basis of the positional relationship between the first electronic device 910-1 and the user and the positional relationship between the second electronic device 910-2 and the user, but the positional relationship between the third electronic device 910-3 located near the first electronic device 910-1 and the second electronic device 910-2 and the user may be determined. The server 905 may identify that the user is located near the third electronic device 910-3 on the basis of at least the positional relationship between the third electronic device 910-3 and the user.

In operation 1840, the server 905 may determine the format of the generated feedback on the basis of at least information on the capability of the third electronic device 910-3 in response to the identification. The server 905 may identify that the third electronic device 910-3 is linked to the first electronic device 910-1 and the second electronic device 910-2 on the basis of a database stored in the memory 1220. The server 905 may inquire about information on the capability of the third electronic device 910-3 within the database on the basis of the identification.

The server 905 may determine a format corresponding to the capability of the third electronic device 910-3 as the format of the feedback on the basis of the inquiry. For example, when the output device of the third electronic device 910-3 is a display, the server 905 may determine a format for screen display as the format of the feedback. In another example, when the output device of the third electronic device 910-3 is a speaker, the server 905 may determine a format for audio output as the format of the feedback.

In operation 1845, the server 905 may transmit information on feedback having the determined format to the third electronic device 910-3. The third electronic device 910-3 may receive information on the feedback having the determined format. For example, referring to

FIG. 19, the third electronic device 910-3 may transmit the information on the feedback having the format for screen output to the third electronic device 910-3 on the basis of identification that the output device of the third electronic device 910-3 is the display. In another example, referring to FIG. 19, the third electronic device 910-3 may transmit information on the feedback having the format for audio output to the third electronic device 910-3 on the basis of identification that the output device of the third electronic device 910-3 is the speaker. The third electronic device 910-3 may receive the information on the feedback.

In operation 1850, the third electronic device 910-3 may provide feedback on the basis of the received information. For example, referring to FIG. 19, the third electronic device 910-3 may provide visual content indicating current weather information of New York as the feedback on the basis of the received information. In another example, referring to FIG. 19, the third electronic device 910-3 may provide audio content indicating current weather information of New York as the feedback on the basis of the received information.

Although FIG. 18 illustrates an example in which the server 905 provides information on the feedback to the third electronic device 910-3, that is, to one device, the server 905 may provide the information on the feedback to each of the plurality of electronic devices. For example, when the feedback is music reproduction, the server 905 may provide information on feedback having different sound characteristics to the plurality of electronic devices capable of reproducing music, so as to provide a surround sound or a sound for 5.1 channels through the plurality of electronic devices. In another example, when the feedback is information provision, the server 905 may provide information on feedback having different formats to an electronic device including a speaker and another electronic device including a display, so as to provide an audio signal through the electronic device and provide screen output through the another electronic device.

As described above, the server 905 according to various embodiments may receive information indicating the reception quality of the voice signal from each of the plurality of electronic devices so as to determine the positional relationship between the user making the voice signal and each of the plurality of electronic devices. The server 905 may provide feedback through the electronic device located near the user among the plurality of electronic devices on the basis of the determination. Also, the server 905 may more efficiently provide service by adaptively changing the format of the feedback on the basis of the capability of the electronic device to provide feedback.

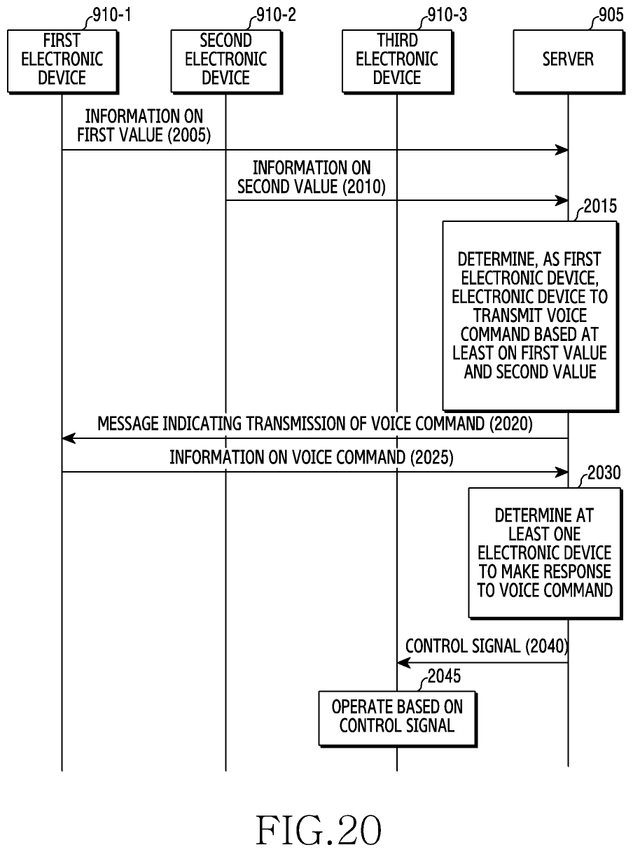

FIG. 20 illustrates another example of signaling between a plurality of electronic devices and a server according to various embodiments. The signaling may be performed between the plurality of electronic devices (for example, the electronic devices 910-1 to 910-N) illustrated in FIG. 9 and the server 905 illustrated in FIG. 9.

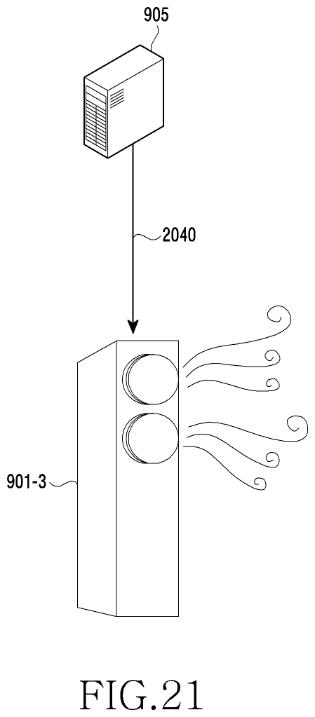

FIG. 21 illustrates an example of another operation of the server according to various embodiments.

In operation 2005, the first electronic device 910-1 receiving the voice signal may transmit information on the first value to the server 905. The server 905 may receive the information on the first value.

In operation 2010, the second electronic device 910-2 receiving the voice signal may transmit information on the second value to the server 905. The server 905 may receive the information on the second value.

In operation 2015, the server 905 may determine the electronic device to transmit the voice command included in the voice signal as the first electronic device 910-1 on the basis of at least the first value and the second value.

In operation 2020, the server 905 may transmit a message indicating transmission of the voice command to the server 905 to the first electronic device 910-1. The first electronic device 910-1 may receive the message.

In operation 2025, the first electronic device 910-1 may transmit information on the voice command to the server 905. The server 905 may receive the information on the voice command.

In operation 2030, the server 905 may determine at least one electronic device to make a response to the voice command. The response may be distinct from the feedback. The response may be generated or defined within the server when the voice command requires not only information provision but also another operation. For example, the response may be related to turning on a turned-off device or switching a deactivated device to an activated state. The server 905 may determine the device to be controlled on the basis of the response as the third electronic device 910-3 on the basis of recognition of the voice command.

In operation 2040, the server 905 may transmit a control signal to the third electronic device 910-3 in response to the voice command. For example, referring to

FIG. 21, the server 905 may transmit the control signal for driving an air conditioner to the air conditioner which is the third electronic device 910-3. The air conditioner, which is the third electronic device 910-3, may receive the control signal from the server 905.

In operation 2045, the third electronic device 910-3 may operate on the basis of the control signal. For example, referring to FIG. 21, the third electronic device 910-3 may blow air to keep the air in a building cool on the basis of the control signal received from the server 905.

As described above, the server 905 according to various embodiments may control the device that the voice command targets by recognizing the voice command within the voice signal on the basis of reception of information on a value indicating the reception quality of the voice signal. Through the control, the server 905 may provide seamless service.

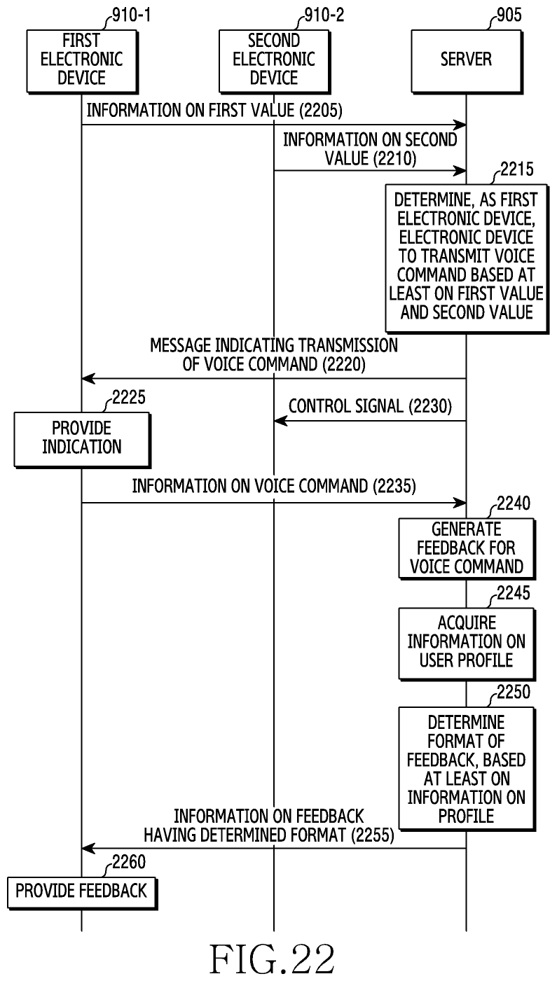

FIG. 22 illustrates another example of signaling between a plurality of electronic devices and a server according to various embodiments. The signaling may be generated between the plurality of electronic devices (for example, the electronic devices 910-1 to 910-N) illustrated in FIG. 9 and the server 905 illustrated in FIG. 9.

Referring to FIG. 22, in operation 2205, the first electronic device 910-1 receiving the voice signal may transmit information on the first value to the server 905. The server 905 may receive the information on the first value.

In operation 2210, the second electronic device 910-2 receiving the voice signal may transmit information on the second value to the server 905. The server 905 may receive the information on the second value.

In operation 2215, the server 905 may determine an electronic device to transmit the voice command as the first electronic device 910-1 on the basis of at least the first value and the second value.

In operation 2220, the server 905 may transmit a message indicating transmission of the voice command included in the voice signal to the first electronic device 910-1. The first electronic device 910-1 may receive the message.

In operation 2225, the first electronic device 910-1 may provide an indication indicating reception of the message in response to reception of the message.

Meanwhile, in operation 2230, the server 905 may transmit a control signal making a request to stop receiving the voice signal to the second electronic device 910-2. The second electronic device 910-2 may receive the control signal.

In operation 2235, the first electronic device 910-1 may transmit information on the voice command to the server 905 on the basis of reception of the message.

In operation 2240, the server 905 may generate feedback for the voice command on the basis of the received information. The server 905 may generate the feedback by recognizing the voice command.

In operation 2245, the server 905 may acquire information on a profile of the user related to the first electronic device 910-1 and the second electronic device 910-2 on the basis of the database stored in the memory 1220. The server 905 may acquire information on the profile, that is, information indicating how the user desires to receive the feedback from the database.

In operation 2250, the server 905 may determine the format of the feedback on the basis of at least information on the acquired profile. For example, when the information on the profile indicates that the user desires voice output, the server 905 may determine the format for voice output as the format of the feedback. In another example, when the information on the profile indicates that the user desires haptic provision, the server 905 may determine a format for haptic provision as the format of the feedback.

In operation 2255, the server 905 may transmit information on feedback having the determined format to the first electronic device 910-1. The first electronic device 910-1 may receive the information.

In operation 2260, the first electronic device 910-1 may provide the feedback on the basis of the received information. The feedback has the determined format on the basis of the user profile, so that the first electronic device 910-1 may provide service suitable for the user state (or context).

As described above, the server 905 according to various embodiments may provide higher convenience to the user by providing the feedback on the basis of the user profile acquired through big data or machine learning and registered in the database.

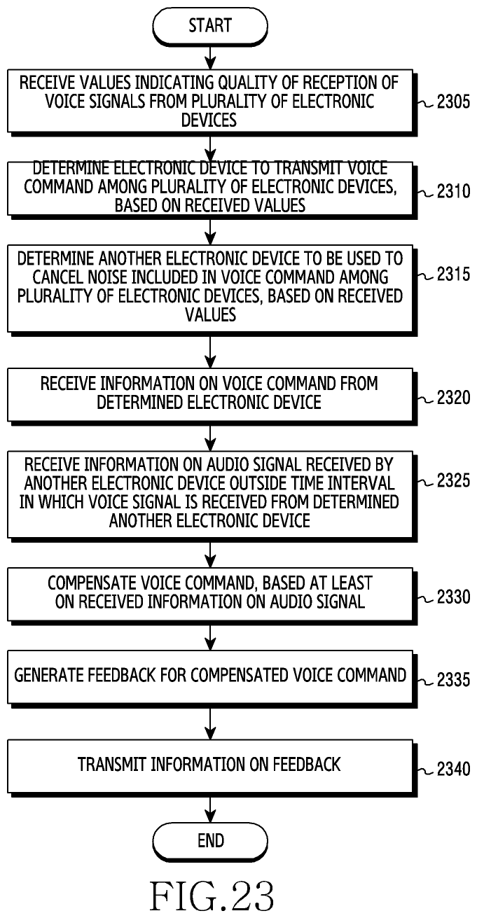

FIG. 23 illustrates an example of an operation of a server performing noise canceling on a voice command according to various embodiments. The operation may be performed by the server 905 or the processor 1210 included in the server 905 illustrated in FIG. 12.

Referring to FIG. 23, in operation 2305, the server 905 may receive values indicating the quality of reception of respective voice signals from a plurality of electronic devices.

In operation 2310, the server 905 may determine the electronic device to transmit the voice command included in the voice signal among the plurality of electronic devices on the basis of the received values. The server 905 may make a request for the voice command to the determined electronic device.

In operation 2315, the server 905 may determine another electronic device to be used to cancel the noise included in the voice command among the plurality of electronic devices on the basis of the received values. For example, the server 905 may determine, as another electronic device, an electronic device transmitting a value having a characteristic different from the characteristic of the value indicating the reception quality of the voice signal transmitted from the electronic device determined in operation 2310 among the plurality of electronic devices. The characteristic may be related to a frequency characteristic of the voice signal. The characteristic may be related to distribution of energy of the voice signal. The server 905 may make a request for information on an audio signal, received by the another electronic device outside the time interval in which the voice signal is received, to the determined another electronic device.

In operation 2320, the server 905 may receive information on the voice command from the determined electronic device.

In operation 2325, the server 905 may receive information on the audio signal, received by the another electronic device outside the time interval in which the voice signal is received, from the determined another electronic device. The information on the audio signal may be related to noise included in the voice command.

In operation 2330, the server 905 may compensate the voice command on the basis of at least the received information on the audio signal. For example, the server 905 may compensate the voice command by removing a frequency component corresponding to the frequency of the received audio signal from the voice command.

In operation 2335, the server 905 may generate feedback for the compensated voice command. For example, the server 905 may recognize the compensated voice command. The server 905 may generate the feedback on the basis of at least the recognized voice command.

In operation 2340, the server 905 may transmit information on the feedback.

As described above, the server 905 according to various embodiments may acquire information on the voice command from the electronic device receiving the voice signal with the highest reception quality and acquire information used to compensate the voice command from another electronic device receiving the voice signal having characteristics different from the characteristics of the voice signal received by the electronic device so as to cancel the noise in the voice command. By canceling the noise, the server 905 according to various embodiments may improve the recognition rate of the voice command. The server 905 according to various embodiments may provide a more robust voice recognition service by canceling noise.

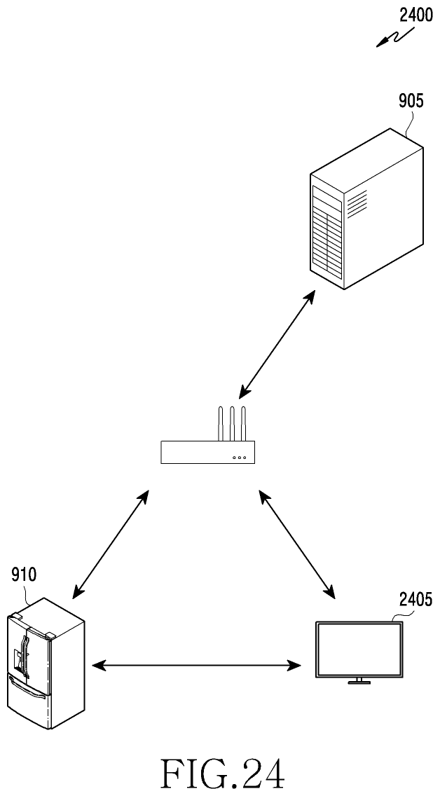

FIG. 24 illustrates another example of an environment including a plurality of electronic devices according to various embodiments.

An environment 2400 may include the server 905, the electronic device 910, and another electronic device 2405.

The server 905 included in the environment 2400 may correspond to the server 905 illustrated in FIGS. 9 and 12.

The electronic device 910 included in the environment 2400 may correspond to the electronic device 910 illustrated in FIGS. 9 and 10.

The electronic device 910 included in the environment 2400 may perform signaling with the server 905 through a wireless Access Point (AP). To this end, the electronic device 910 may generate a communication path between the server 905 and the electronic device 910. The communication path may include a communication path between the server 905 and a wireless AP and a communication path between the electronic device 910 and a wireless AP.

Another electronic device 2405 included in the environment 2400 may be a device newly installed in the environment 2400. The another electronic device 2405 may be a device which is not registered in the database within the server 905.

The another electronic device 2405 may be a fixed device which newly enters the environment 2400. For example, the another electronic device 2405 may be one of a desktop computer, a television (TV), a refrigerator, a washing machine, an air conditioner, a smart light, a Large-Format Display (LFD), a digital signage, or a mirror display.

The another electronic device 2405 may be a device having mobility, which newly enters the environment 2400. For example, another electronic device 2405 may be one of a smartphone, a tablet computer, a laptop computer, a portable game machine, a portable music player, or a vacuum cleaner.

According to various embodiments, the another electronic device 2405 may have a communication function. To this end, the another electronic device 2405 may include a processor and a communication interface. According to various embodiments, the another electronic device 2405 may output an audio signal. To this end, the another electronic device 2405 may include a speaker. According to various embodiments, the another electronic device 2405 may receive an audio signal. To this end, the another electronic device 2405 may include a microphone.

According to various embodiments, the another electronic device 2405 may perform signaling with the electronic device 910. To this end, the another electronic device 2405 may generate a communication path between the electronic device 910 and the another electronic device 2405.

According to various embodiments, the another electronic device 2405 may perform signaling with the server 905. To this end, the another electronic device 2405 may generate a communication path between the another electronic device 2405 and the server 905. The communication path may include a communication path between the another electronic device 2405 and a wireless AP and a communication path between the server 905 and a wireless AP.

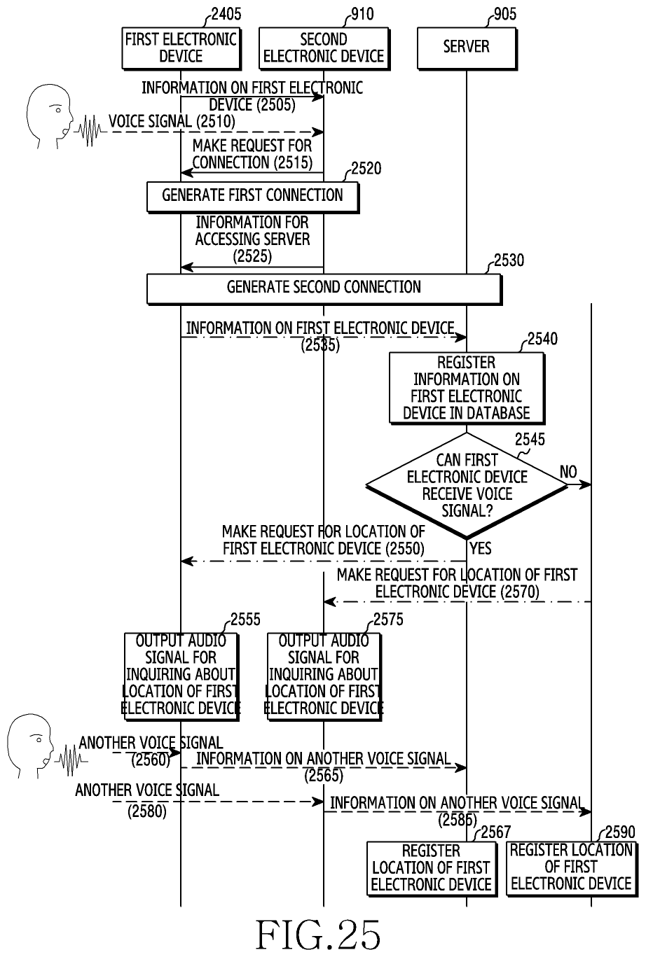

FIG. 25 illustrates another example of signaling between a plurality of electronic devices and a server according to various embodiments. The signaling may be performed by the electronic device 910, the another electronic device 2405, and the server 905 illustrated in FIG. 24.

In FIG. 25, the first electronic device 2405 may be a device that newly enters the environment 2400 including the server 905 and the second electronic device 910.

Referring to FIG. 25, in operation 2505, the first electronic device 2405 may transmit information on the first electronic device 2405 through a communication interface of the first electronic device 2405 in response to acquisition of initial power (or initial turning-on) after newly entering the environment 2400. Information on the first electronic device 2405 may include information for identifying the first electronic device 2405. The information on the first electronic device 2405 may include information (for example, resource information) for accessing the first electronic device 2405. The information on the first electronic device 2405 may include information on a user account related to the first electronic device 2405. The first electronic device 2405 may broadcast information on the first electronic device 2405. The second electronic device 910 may receive the broadcasted information on the first electronic device 2405 in the state in which the second electronic device 910 is not connected to the first electronic device 2405 (or before the connection with the first electronic device 2405 is established).

In operation 2510, the second electronic device 910 may receive the voice signal through the microphone 1020 of the second electronic device 910. The voice signal may include a voice command indicating registration of the first electronic device 2405. The voice signal may include a voice command indicating new entry of the first electronic device into the environment 2400.

In operation 2515, the second electronic device 910 may make a request for connection to the first electronic device 2405 on the basis of the received information on the first electronic device 2405 in response to reception of the voice signal.

In operation 2520, the first electronic device 2405 and the second electronic device 910 may generate a first connection on the basis of the request for the connection from the second electronic device 910. The first connection may indicate a connection between the first electronic device 2405 and the second electronic device 910. The first connection may be related to a first communication scheme. For example, the first connection may be a direct connection between devices. For example, the first connection may be a Bluetooth connection, a BLE connection, an LTE sidelink connection, or a Wi-Fi direct connection.

In operation 2525, the second electronic device 910 may transmit information for accessing the server 905 through the first connection to the first electronic device 2405. For example, the information for accessing the server 905 may include information for identifying the server 905 and information on resources required for accessing the server 905. The first electronic device 2405 may receive the information for accessing the server 905 through the first connection.

In operation 2530, the first electronic device 2405 may generate a second connection with the server 905 by making a request for the connection to the server 905 on the basis of the information for accessing the server 905. The second connection may indicate a connection between the first electronic device 2405 and the server 905. The second connection may be related to a second communication scheme different from the first communication scheme. For example, the second connection may be an indirect connection that needs an intermediate node. For example, the second connection may be an LTE connection or a Wi-Fi connection.

In operation 2535, the first electronic device 2405 may transmit information on the first electronic device 2405 to the server 905 through the second connection. The server 905 may receive information on the first electronic device 2405 from the first electronic device 2405 through the second connection. The information on the first electronic device 2405 received by the server 905 may include information for managing the first electronic device 2405 by the server 905 in the future. The information on the first electronic device 2405 received by the server 905 may include at least one of information on the capability of the first electronic device 2405, information on various identifiers of the first electronic device 2405, or information on a user account related to the first electronic device 2405.

In operation 2540, the server 905 may register information on the first electronic device 2405 in the database. For example, the server 905 may register data indicating that the first electronic device 2405 is related to the second electronic device 910. For example, the server 905 may register data on the capability of the first electronic device 2405. The server 905 may store the information on the first electronic device 2405 in the database in order to manage the newly entered first electronic device 2405 in the future. The server 905 may store not only information received from the first electronic device 2405 but also information on the first electronic device 2405 acquired through a web search in the database.

In operation 2545, the server 905 may determine whether the first electronic device 2405 is capable of receiving a voice signal on the basis of at least the information on the first electronic device 2405. For example, when the information on the first electronic device 2405 indicates that the first electronic device 2405 includes a microphone, the server 905 may perform operation 2550. In another example, when the information on the first electronic device 2405 indicates that the first electronic device 2405 does not include a device for receiving a voice signal such as a microphone, the server 905 may perform operation 2570.

In operation 2550, the server 905 may make a request for the location of the first electronic device 2405 to the first electronic device 2405 on the basis of the determination that the first electronic device 2405 is capable of receiving a voice signal. For example, the server 905 may transmit a message making a request for transmitting the location of the first electronic device 2405 to the first electronic device 2405. The first electronic device 2405 may receive the message.

In operation 2555, the first electronic device 2405 may output an audio signal for inquiring about the location of the first electronic device 2405 through a speaker of the first electronic device 2405. The first electronic device 2405 may output an audio signal for guiding the user to input the location of the first electronic device 2405 through an audio signal through the speaker of the first electronic device 2405.

In operation 2560, the first electronic device 2405 may receive another voice signal through a microphone of the first electronic device 2405 in response to the audio signal. Another voice signal may include information indicating the location of the first electronic device 2405.

In operation 2565, the first electronic device 2405 may transmit information on another voice signal to the server 905. The server 905 may receive information on another voice signal.

In operation 2567, the server 905 may register the location of the first electronic device 2405 in the database on the basis of the information on another voice signal. The server 905 may acquire information on the location of the first electronic device 2405 on the basis of recognition of another voice signal. The server 905 may register the acquired information in the database.

In operation 2570, the server 905 may make a request for the location of the first electronic device 2405 to the second electronic device 910 on the basis of the determination that the first electronic device 2405 is not capable of receiving a voice signal. The second electronic device 910 may receive the request.

In operation 2575, the second electronic device 910 may output an audio signal for inquiring about the location of the first electronic device 2405 through a speaker of the second electronic device 910. The second electronic device 910 may output an audio signal for guiding the user to input the location of the first electronic device 2405 through a voice signal through the speaker of the second electronic device 910.

In operation 2580, the second electronic device 910 may receive another voice signal through a microphone of the second electronic device 910 in response to the audio signal. Another voice signal may include information indicating the location of the first electronic device 2405.

In operation 2585, the second electronic device 910 may transmit information on another voice signal to the server 905. The server 905 may receive information on another voice signal.

In operation 2590, the server 905 may register the location of the first electronic device 2405 in the database on the basis of information on another voice signal. The server 905 may acquire information on the location of the first electronic device 2405 on the basis of recognition of another voice signal. The server 905 may register the acquired information in the database.

As described above, through signaling with a newly entered electronic device and an electronic device located near the newly entered electronic device, the server 905 according to various embodiments may register the newly entered electronic device and the location of the newly entered electronic device through a voice signal. Further, the server 905 according to various embodiments may increase user convenience by adaptively changing signaling according to whether the newly entered electronic device is capable of recognizing a voice signal.

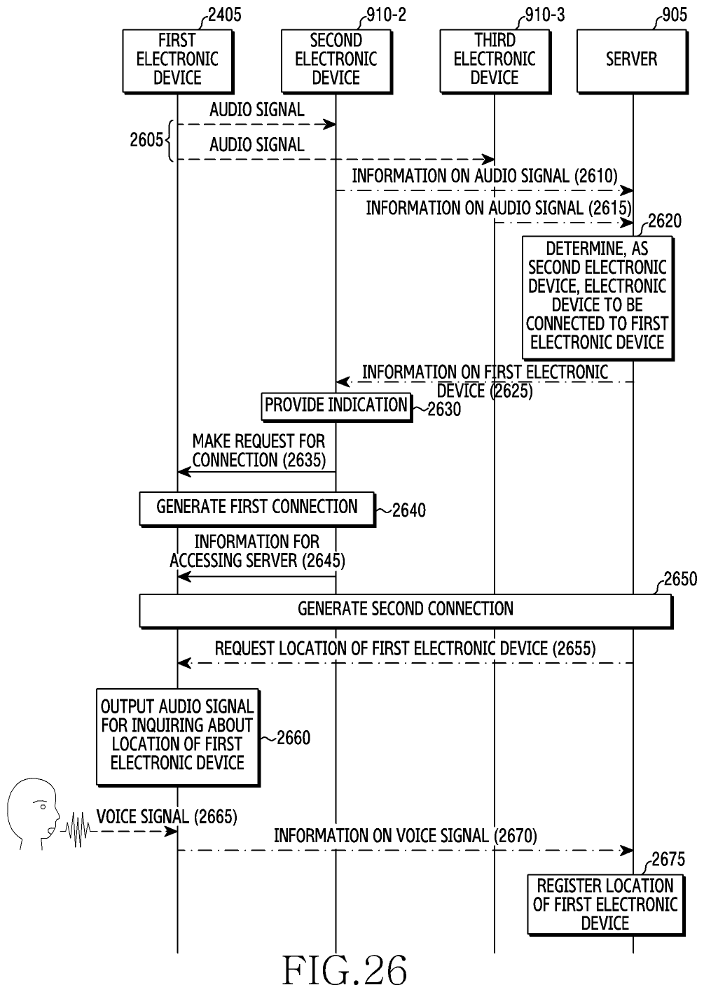

FIG. 26 illustrates another example of signaling between a plurality of electronic devices and a server according to various embodiments. The signaling may be performed by the electronic device 910, another electronic device 2405, and the server 905 illustrated in FIG. 24.

In FIG. 26, the first electronic device 2405 may be a device that newly enters the environment 2400 including the server 905, the second electronic device 910-2, and the third electronic device 910-3.

Referring to FIG. 26, in operation 2605, the first electronic device 2405 may output an audio signal through a speaker of the first electronic device 2405 in response to initial acquisition of power (or initial turning-on) after the first electronic device 2405 newly enters the environment 2400. According to various embodiments, the audio signal may include information indicating that the first electronic device 2405 newly enters the environment 2400. According to various embodiments, the audio signal may include information for identifying the first electronic device 2405. According to various embodiments, the information may or may not be audible to the user. According to various embodiments, the information may be watermarked on the audio signal. The second electronic device 910-2 and the third electronic device 910-3 may receive the audio signal.

In operation 2610, the second electronic device 910-2 may transmit information on the audio signal to the server 905. The server 905 may receive the information on the audio signal.

In operation 2615, the third electronic device 910-3 may transmit the information on the audio signal to the server 905. The server 905 may receive the information on the audio signal.

In operation 2620, the server 905 may determine the electronic device to be connected to the first electronic device as the second electronic device 910-2. For example, the server 905 may determine that the second electronic device 910-2 is located closer to the first electronic device 2405 on the basis of the information on the audio signal received from the second electronic device 910-2 and the information on the audio signal received from the third electronic device 910-3.

The server 905 may determine the electronic device to be connected to the first electronic device 2405 as the second electronic device 910-2 on the basis of the determination.

When the environment 2400 does not include the third electronic device 910-3, it should be noted that operation 2615 and operation 2620 may be omitted or bypassed.

In operation 2625, the server 905 may transmit information on the first electronic device 2405 to the second electronic device 910-2. For example, the information on the first electronic device 2405 may include information for accessing the first electronic device 2405. The second electronic device 910-2 may receive the information on the first electronic device 2405.

In operation 2630, the second electronic device 910-2 may provide an indication in response to reception of the information. The indication may be used to indicate that the second electronic device 910-2 is selected as an electronic device to be linked with the first electronic device 905 by the server 905. Operation 2630 may be bypassed or omitted.

In operation 2635, the second electronic device 910-2 may make a request for the connection with the first electronic device 2405 on the basis of the received information on the first electronic device 2405.

In operation 2640, the first electronic device 2405 and the second electronic device 910-2 may generate the first connection on the basis of the request for the connection.

In operation 2645, the second electronic device 910-2 may provide information for accessing the server 905 to the first electronic device 2405 through the first connection on the basis of generation of the first connection.

In operation 2650, the first electronic device 2405 may generate a second connection with the server 905 by making a request for the connection to the server 905 on the basis of the information for accessing the server 905. The second connection may indicate a connection between the server 905 and the first electronic device 2405.

In operation 2655, the server 905 may make a request for the location of the first electronic device 2405 through the second connection. The first electronic device 2405 may receive the request through the second connection.

In operation 2660, the first electronic device 2405 may output an audio signal for inquiring about the location of the first electronic device 2405 on the basis of the request received from the server 905. The audio signal may guide the user to input the location of the first electronic device 2405 through a voice input.

In operation 2665, the first electronic device 2405 may receive a voice signal through a microphone of the first electronic device 2405. The voice signal may be a user response to the output audio signal. The voice signal may include information indicating the location of the first electronic device 2405.

In operation 2670, the first electronic device 2405 may transmit information on the voice signal to the server 905 through the second connection. The server 905 may receive information on the voice signal through the second connection.

In operation 2675, the server 905 may register the location of the first electronic device 2405 on the basis of the information on the voice signal. For example, the server 905 may acquire information on the location of the first electronic device 2405 by recognizing the voice signal. The server 905 may store the location of the first electronic device 2405 in the database on the basis of the acquisition.

As described above, the plurality of electronic devices and the server 905 according to various embodiments may register the location of the newly entered electronic device through the voice input. The registration is performed through transparent communication signaling of the user and seamless voice input of the user, and thus the plurality of electronic devices and the server 905 according to various embodiments may provide higher convenience.

A method of a system according to various embodiments as described above may include an operation of receiving first data including first voice data related to a first user utterance and first metadata related to the first voice data through the network interface of the system from a first external device, an operation of receiving second data including second voice data related to the first user utterance and second metadata related to the second voice data from a second external device through the network interface, an operation of selecting one device from among the first external device and the second external device on the basis of at least the first metadata and the second metadata, an operation of providing a response related to the one selected device to the one selected device, and an operation of receiving third data related to a second user utterance from the one selected device.

According to various embodiments, each of the first metadata and the second metadata may include at least one of an audio gain, a wake-up command confidence level, or a Signal-to-Noise Ratio (SNR).

A method of an electronic device according to various embodiments as described above may include an operation of receiving a first user utterance through the microphone of the electronic device, an operation of transmitting first data including first voice data related to the first user utterance and first metadata related to the first voice data to an external server through the wireless communication circuit, and an operation of receiving a response related to an electronic device selected as an input device for a voice-based service from the external server through the wireless communication circuit.

According to various embodiments, the first metadata may include at least one of an audio gain, a wake-up command confidence level, or a Signal-to-Noise Ratio (SNR).

A method of an electronic device according to various embodiments as described above may include an operation of receiving a voice signal through the microphone, an operation of identifying a wake-up command within the voice signal, an operation of determining a value indicating a reception quality of the voice signal on the basis of at least the wake-up command, and an operation of transmitting information on the determined value to a server through the communication interface of the electronic device.

According to the various embodiments, the voice signal may further include a voice command subsequent to the wake-up command, and the operation of transmitting the information on the determined value may include an operation of transmitting the information on the determined value to the server through the communication interface of the electronic device in order to allow the server to determine the device to transmit information on the voice command to the server among a plurality of electronic devices including the electronic device and at least one other electronic device receiving the voice signal. According to various embodiments, the method may further include an operation of receiving a message indicating transmission of the voice command to the server from the server through the communication interface, an operation of transmitting the information on the voice command to the server through the communication interface in response to the reception, and an operation of providing an indication through the output device of the electronic device in response to the reception. According to various embodiments, the message may be transmitted from the server to the electronic device on the basis of at least the information on the determined value and information on at least one other value, which is transmitted from the at least one other electronic device to the server and indicates the reception quality of the voice signal in the at least one other electronic device.

According to various embodiments, the method may further include an operation of providing, through the output device of the electronic device, an indication indicating reception of the voice signal after the reception of the voice signal is completed.

According to various embodiments, the method may further include an operation of providing, through the output device of the electronic device, an indication indicating reception of the voice signal within the duration of silence between the wake-up command and the voice command.

According to various embodiments, the operation of receiving the voice signal may include an operation of receiving the voice signal through the microphone, based on a first clock frequency by the audio codec chip of the electronic device, and the operation of identifying the wake-up command may include an operation of identifying the wake-up command within the voice signal in response to the reception, an operation of transmitting a signal for switching the state of the application processor of the electronic device to a wake-up state to the application processor in response to the identification, and an operation of transmitting information on the identified wake-up command to the processor switching to the wake-up state by the audio codec chip, the operation of determining the value may include an operation of determining the value indicating the reception quality of the voice signal on the basis of at least the information on the identified wake-up command by the processor switching to the wake-up state, and the operation of transmitting the information may include an operation of transmitting information on the determined value to the server through the communication interface by the processor switching to the wake-up state. According to various embodiments, the method may further include an operation of buffering the voice signal until the processor switches to the wake-up state and an operation of providing information on the buffered voice signal to the processor in response to identification that the processor switches to the wake-up state by the audio codec chip.

A method of a server according to various embodiments as described above may include an operation of receiving information on a first value indicating a reception quality of a voice signal received by a first electronic device from the first electronic device through the communication interface of the server, an operation of receiving information on a second value indicating a reception quality of the voice signal received by a second electronic device from the second electronic device through the communication interface, an operation of determining an electronic device to transmit a voice command included in the voice signal among a plurality of electronic devices including the first electronic device and the second electronic device on the basis of at least the first value and the second value, and an operation of transmitting a message indicating transmission of information on the voice command to the determined electronic device through the communication interface.

According to various embodiments, the operation of receiving the information on the second value may include an operation of receiving, from the second electronic device, the information on the second value indicating the reception quality of the voice signal received by the second electronic device within a predetermined time interval from the time point at which the information on the first value is received through the communication interface.

According to various embodiments, each of the first value and the second value may be included in the voice signal and is determined based at least on a wake-up command prior to the voice command.

According to various embodiments, the operation of transmitting the message may include an operation of determining the first electronic device as the electronic device to transmit the voice command on the basis of identification that the first value is higher than the second value and transmitting the message indicating transmission of the information on the voice command to the first electronic device through the communication interface and an operation of determining the second electronic device as the electronic device to transmit the voice command on the basis of identification that the first value is lower than the second value and transmitting the message indicating transmission of the information on the voice command to the second electronic device through the communication interface.

According to various embodiments, the method may further include an operation of receiving information on the voice command from the determined electronic device through the communication interface in response to the message, an operation of generating feedback for the voice command, and an operation of transmitting information on the feedback through the communication interface. According to various embodiments, the operation of transmitting the information on the feedback may include an operation of identifying that a user related to the voice signal is located near a third electronic device among the plurality of electronic devices, based at least on the first value and the second value, an operation of acquiring information on the capability of the third electronic device from a database stored in a memory of the server, an operation of determining the format of the feedback on the basis of at least the information on the capability of the third electronic device, and an operation of transmitting the information on the feedback having the determined format to the third electronic device through the communication interface. According to various embodiments, the format may include one or more of voice output, screen display, light emission, or haptic provision.

According to various embodiments, the method may further include an operation of determining at least one electronic device to make a response to the voice command among the plurality of electronic devices and an operation of transmitting a control signal related to the response to the at least one electronic device through the communication interface in order to allow the at least one electronic device to operate on the basis of the response.

According to various embodiments, the method may further include an operation of determining another electronic device distinct from the electronic device determined among the plurality of electronic devices on the basis of at least the first value and the second value, an operation of transmitting another message indicating transmission of information on an audio signal received by the another electronic device outside the time interval in which the voice signal is received to the another electronic device through the communication interface, an operation of receiving the information on the audio signal in response to the another message from the determined another electronic device through the communication interface, an operation of compensating the voice command on the basis of at least the information on the audio signal, an operation of generating feedback for the compensated voice command, and an operation of transmitting information on the feedback through the communication interface.

According to various embodiments, the operation of transmitting the information on the feedback may include an operation of acquiring information on a user profile related to the first electronic device and the second electronic device from the database, an operation of determining the format of the feedback on the basis of at least the information on the profile, and an operation of transmitting the information on the feedback having the determined format through the communication interface.

A method of an electronic device according to various embodiments as described above may include an operation of outputting an audio signal through a speaker of the electronic device, an operation of receiving the audio signal through a communication interface of the electronic device and receiving a signal making a request for a connection from an external electronic device connected to a server, an operation of generating the connection between the electronic device and the external electronic device on the basis of at least the received signal, an operation of receiving information for accessing the server through the connection from the external electronic device through the communication interface, an operation of accessing the server on the basis of at least the information through the communication interface, an operation of receiving a message making a request for the location of the electronic device from the server through the communication interface, and an operation of outputting another audio signal for inquiring about the location of the electronic device through the speaker in response to the reception of the message.

According to various embodiments, the method may further include an operation of transmitting information on the electronic device through the communication interface in order to register the electronic device in the server after access to the server, and the message may be transmitted from the server to the electronic device in response to registration of the electronic device on the basis of at least the information on the electronic device.

According to various embodiments, the method may further include an operation of receiving a response to the another audio signal through the microphone and an operation of transmitting information on the response to the server through the communication interface.

Methods disclosed in the claims and/or methods according to various embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, modifications and changes may be made thereto without departing from the scope of the disclosure. Therefore, the scope of the disclosure should not be defined as being limited to the embodiments, but should be defined by the appended claims and equivalents thereof.

1. An electronic device comprising:
a microphone;
a communication interface; and
at least one processor,
wherein the at least one processor is configured to receive a voice signal through the microphone, identify a wake-up command within the voice signal, determine a value indicating a reception quality of the voice signal, based at least on the wake-up command, and transmit information on the determined value to a server through the communication interface.

2. The electronic device of claim 1, wherein the voice signal further includes a voice command subsequent to the wake-up command, and the at least one processor is configured to transmit the information on the determined value to the server through the communication interface in order to allow the server to determine a device to transmit information on the voice command to the server among a plurality of electronic devices including the electronic device and at least one other electronic device receiving the voice signal.

3. The electronic device of claim 2, further comprising an output device, wherein the at least one processor is further configured to receive a message indicating transmission of the voice command to the server from the server through the communication interface, transmit the information on the voice command to the server through the communication interface in response to the reception, and provide an indication through the output device in response to the reception.

4. The electronic device of claim 3, wherein the message is transmitted from the server to the electronic device, based at least on the information on the determined value and information on at least one other value, which is transmitted from the at least one other electronic device to the server and indicates the reception quality of the voice signal in the at least one other electronic device.

5. The electronic device of claim 4, further comprising an output device, wherein the at least one processor is further configured to provide, through the output device, an indication indicating reception of the voice signal after the reception of the voice signal is completed.

6. The electronic device of claim 1, further comprising an output device, wherein the at least one processor is further configured to provide, through the output device, an indication indicating reception of the voice signal within a duration of silence between the wake-up command and the voice command.

7. The electronic device of claim 1, wherein the at least one processor includes an application processor and an audio codec chip, and the audio codec chip is configured to receive the voice signal through the microphone, based on a first clock frequency, identify the wake-up command within the voice signal in response to the reception, transmit a signal for switching a state of the application processor to a wake-up state to the application processor in response to identification, and transmit information on the identified wake-up command to the processor switching to the wake-up state, and the processor switching to the wake-up state is configured to determine the value indicating the reception quality of the voice signal, based at least on the information on the identified wake-up command and transmit information on the determined value to the server through the communication interface.

8. The electronic device of claim 7, wherein the audio codec chip is further configured to buffer the voice signal until the processor switches to the wake-up state and provide information on the buffered voice signal to the processor in response to identification that the processor switches to the wake-up state.

9. A server comprising:
a communication interface; and
a processor,
wherein the processor is configured to receive information on a first value indicating a reception quality of a voice signal received by a first electronic device from the first electronic device through the communication interface, receive information on a second value indicating a reception quality of the voice signal received by a second electronic device from the second electronic device through the communication interface, determine an electronic device to transmit a voice command included in the voice signal among a plurality of electronic devices including the first electronic device and the second electronic device, based at least on the first value and the second value, and transmit a message indicating transmission of information on the voice command to the determined electronic device through the communication interface.

10. The server of claim 9, wherein the processor is configured to receive, from the second electronic device, the information on the second value indicating the reception quality of the voice signal received by the second electronic device within a predetermined time interval from the time point at which the information on the first value is received through the communication interface.

11. The server of claim 9, wherein each of the first value and the second value is included in the voice signal and is determined based at least on a wake-up command prior to the voice command.

12. The server of claim 9, wherein the processor is configured to determine the first electronic device as an electronic device to transmit the voice command based on identification that the first value is higher than the second value, transmit the message indicating transmission of the information on the voice command to the first electronic device through the communication interface, determine the second electronic device as the electronic device to transmit the voice command based on identification that the first value is lower than the second value, and transmit the message indicating transmission of the information on the voice command to the second electronic device through the communication interface.

13. The server of claim 9, wherein the processor is further configured to receive information on the voice command from the determined electronic device through the communication interface in response to the message, generate feedback for the voice command, and transmit information on the feedback through the communication interface.

14. The server of claim 13, wherein the processor is configured to identify that a user related to the voice signal is located near a third electronic device among the plurality of electronic devices, based at least on the first value and the second value, acquire information on a capability of the third electronic device from a database stored in a memory of the server, determine a format of the feedback, based at least on the information on the capability of the third electronic device, and transmit the information on the feedback having the determined format to the third electronic device through the communication interface.

15. The server of claim 13, wherein the processor is further configured to determine at least one electronic device to make a response to the voice command among the plurality of electronic devices and transmit a control signal related to the response to the at least one electronic device through the communication interface in order to allow the at least one electronic device to operate based on the response.
